(19) United States
(12) Patent Application Publication
(10) Pub. No.: US 2015/0248047 A1
(43) Pub. Date: Sep. 3, 2015

(54) Terahertz Mixer and Optical Fiber Coupled Terahertz Mixer

(71) Applicant: The University of Manchester, Manchester (GB)

(72) Inventor: Subhasish CHAKRABORTY, Manchester (GB)

(21) Appl. No.: 14/632,526

(22) Filed: Feb. 26, 2015

(30) Foreign Application Priority Data
Feb. 28, 2014 (GB) 1403579.4
Jan. 27, 2015 (GB) 1501355.0

(51) Int. Cl. G02F 1/35; G02F 1/377; G02B 27/42; G02F 1/365; G02F 1/355

(52) U.S. Cl. CPC G02F 1/353; G02F 1/365; G02F 1/3544; G02F 1/3556; G02B 27/4244; G02F 1/377; G02F 2001/3546; G02F 2203/13; G02F 2001/354

(57) ABSTRACT

A tunable mixer comprising:
a solid state device formed of a (non-linear) material having a second or higher order electrical susceptibility, and configured to receive an input light signal having a principle modal frequency; and
a grating, provided as a series of a plurality of grating elements, arranged to provide distributed feedback within the device such that the mixer is electrically controllable:
   to add, relative to the principle modal frequency, a sideband mode to the input light signal at any selected one of at least two respective sideband modal frequencies; and
   to output the resulting signal.

### FIELD OF THE INVENTION

The present invention relates to a tunable mixer, in particular but not exclusively to a tunable terahertz (THz) mixer incorporating a distributed feedback grating, and to a phase locked loop THz-over-fiber system incorporating a tunable terahertz mixer.

### BACKGROUND OF THE INVENTION

Nearly all high bandwidth fiber-optic communications systems operate in the infra-red region of the electromagnetic spectrum, namely wavelengths near 1.3 um and 1.5 um. In such a system lasers operating at these wavelengths are modulated digitally to encode the binary data of information packets and are injected into optical fibers of lengths from meters to thousands of kilometres. Various components handle the optical signal, including filters, switches, amplifiers and ultimately detectors to convert the optical signal back into an electronic one. The bandwidth of the telecoms system is ultimately limited by the modulation rate of the 1.3 um or 1.5 um lasers and the speed response of the detectors, although every component in the entire system needs to be capable of handling the modulation or be transparent to it. Real-world systems are currently limited to around 100 GHz or less.

THz modulation would increase bandwidth by at least an order of magnitude. After a decade of bandwidth oversupply following the dotcom crash new video and HD TV on demand services are again driving up the demand for additional bandwidth. THz modulation is however currently impossible mainly because the various components in the system are not compatible with such high operation frequencies.

In order to meet market pressures for high data bandwidths, new communication architectures and components based on coherent technology—where it allows the increase in spectral efficiency within the existing fiber optic communication systems—have been implemented. Furthermore, as the speed of many conventional communications components are limited by the fundamental properties of the materials, in order to go beyond GHz bandwidths into the terahertz (THz) frequency range, new technologies—such as the so-called THz-over-fiber (ToF) systems—are needed.

Dhillon et al. demonstrated in Nature Photonics Vol 1, July 2007 p. 411-415 that a near infra-red (NIR) beam can be coupled into a THz quantum cascade laser (QCL) emitting at 2.8 THz, such that the interaction of the frequencies within the laser material of the device generates THz sidebands. However, the device proposed in this prior art can only produce sidebands at fixed frequencies with respect to the NIR frequency, because the sidebands are generated as a cause of the fundamental characteristics of the device structure and materials. In other words it is not possible to tune the sidebands within the device itself.

It has been demonstrated that owing to the anomalous material dispersion, polaritonic-phase-matching (PPM) is possible leading to the efficient mixing of THz and optical frequencies. However, the PPM technique lacks tunability.

### SUMMARY OF THE INVENTION

The present invention is made in view of the above, and proposes a tunable mixer as set forth in claim 1.

Accordingly, in embodiments, the present invention provides a THz up-conversion arrangements that can produce frequency switchable ToF. For example, for the first time, electrically switchable QCL emission around 2.86 THz is transferred as sidebands onto a NIR carrier around 1300 nm and transmitted over telecoms fiber optic cable, as confirmed by independent spectral characterization in the THz and NIR ranges. The THz sidebands follow the observed QCL modal behaviour, with discrete tuning steps of ˜25 GHz, and can be electrically switched.

It is currently believed that the present invention is founded on the ability of an ADFB filter to directly control the nonlinear optical mixing process. Thus, in the embodiments discussed here, up-conversion of the THz QCL emission relies upon the nonlinear second-order susceptibility of bulk GaAs, which forms the majority of the laser waveguide. The nonlinear optical mixing process, and therefore the conversion efficiency, is highly sensitive to the phase matching of the NIR and THz waves. Although there has been significant development in enhancing nonlinearities in QCLs for such applications, thus far it has been impossible to simultaneously engineer both the lasing emission and nonlinear optical processes monolithically. This will be required if such devices are to be used in realistic coherent systems, where multi frequency operation is required.

The present invention exploits the spectral flexibility provided by the ADFB gratings, incorporated directly into a waveguide formed of a non-linear material, e.g. a QCL, which can provide electronically tunable waveguide dispersion. As discussed below, the present invention provides electronic tuning of the phase-matching process in THz QCLs for example, without the need for multiple devices.

Optionally, the mixer is electrically controllable to select the desired sideband mode frequency by adjustment of an electrical current input to the device.

The grating elements may be arranged to provide scattering sites for radiation propagating in the device, and the tunable mixer may further include a graphene film provided for at least one of the grating elements, arranged to alter the scattering effect of the at least one grating element.

The grating elements may be arranged to provide scattering sites for radiation propagating within the device; and the mixer may further include a first graphene film provided for each grating element of a first set of said grating elements, said first set of grating elements including at least one of the plurality of grating elements; and a second graphene film provided for each grating element of a second set of said grating elements, said second set of grating elements including another at least one of the plurality of grating elements; wherein the first graphene film is controllable, independently of the second graphene film, to alter the scattering effect of the first set of grating elements on the radiation propagating in the device thereby to permit selection of the frequency of the sideband mode.

The first and second graphene films may be independently controllable respective portions of the same graphene film.

The device optionally includes a waveguide portion for guiding the input light signal through the device. The waveguide may be formed as a containment layer within the device for guiding the input light signal through the device.

The grating elements may be arranged as a periodic series.

The grating elements may be arranged as an aperiodic series arranged to provide distributed feedback within the device such that the mixer is electrically controllable: to add, relative to the principle modal frequency, a sideband mode to the input light signal at any selected one of at least three respective sideband modal frequencies; and to output the resulting signal

The device may be optically coupled to an optical input element to receive the input light signal therefrom, and optically coupled to an optical output element arranged to receive the signal output by the device including the principal mode and sideband mode.

The optical input element and/or the optical output element includes an optical fiber.

The device may be at least a portion of a solid state laser device. The laser may be a semiconductor laser. The laser may be a quantum cascade laser.

The principle mode of the input light signal is principally in the near-infra red portion of the electromagnetic spectrum.

The sideband mode frequency differs from the principle mode by less than 50 THz. The sideband mode frequencies may differ from the principle mode by less than 10 THz.

In an aspect the present invention also provides a phase locked terahertz mixing circuit comprising: a terahertz mixer including a solid state device formed of a (non-linear) material having a second or higher order electrical susceptibility configured to receive an input light signal having a principle modal frequency, wherein the solid state device is electrically controllable to add, relative to the principle modal frequency, a sideband mode at a sideband modal frequency and to output the resulting signal; a control sub-circuit including a comparison portion arranged to compare the instantaneous phase-angle of the sideband mode included in the signal output by the terahertz mixer with that of a reference signal at a reference frequency, and a control portion arranged to control the instantaneous phase angle of the sideband mode signal in the signal output by the terahertz mixer on the basis of the comparison.

The phase locked circuit may be an optical phase locked loop circuit.

The comparison portion may be arranged to make the comparison by determining a difference between the instantaneous phase-angle of the sideband mode in the resulting signal output by the terahertz mixer and the reference signal; and the control portion may be arranged to control the instantaneous phase angle of the sideband mode in the signal output by the terahertz mixer on the basis of the determined difference.

The comparison portion is optionally adapted to use a square law detector to measure the difference.

The control portion may be arranged to control the instantaneous phase angle of the sideband mode in the signal output by the terahertz mixer to control the determined difference between the output sideband modal frequency and the reference frequency.

The difference may be compared using a phase frequency detector to produce a control signal.

The control portion may be arranged to control the sideband mode instantaneous phase-angle through electrical control of the terahertz mixer.

The terahertz mixer may further include a grating, provided as a series of a plurality of grating elements, arranged to provide distributed feedback within the device such that the mixer is electrically controllable to add, relative to the principle modal frequency, a sideband mode to the input light signal at any selected one of at least two respective sideband modal frequencies.

The phase locked terahertz mixing circuit may further include an optical fiber arranged to receive the signal output by the terahertz mixer and convey the signal along at least a portion of its length. The optical fiber may be coupled to the terahertz mixer to receive the signal output thereby.

The comparison portion may be arranged to make the comparison on the basis of the signal conveyed by the optical fiber.

The phase locked terahertz mixing circuit may further include an input optical fiber arranged to couple the input signal into the terahertz mixer.

The instantaneous phase angle referred to herein indicates both frequency and phase.

In an aspect, the present invention provides a method of controlling a phase locked terahertz mixing circuit as described herein, the method comprising the steps of: acquiring an output signal of the terahertz mixer having a principal mode at a principal modal frequency and a sideband mode at a sideband modal frequency; comparing the instantaneous phase-angle of the sideband mode signal with that of the reference signal; controlling the value of the sideband modal frequency and phase output by the terahertz mixer on the basis of the comparison.

The step of comparing may include a step of determining an instantaneous phase-angle difference between the sideband mode signal and the reference signal; and the step of controlling may include the step of controlling the value of the instantaneous phase-angle sideband mode output by the terahertz mixer on the basis of the determined difference.

The method may include the step of controlling the terahertz mixer to control (e.g. minimize) the determined instantaneous phase-angle difference between the output sideband mode signal and the reference signal.

The mixer may include a solid state device formed of a (non-linear) material having a second or higher order electrical susceptibility configured to receive an input light signal at the principle modal frequency; wherein the method optionally includes: electrically controlling the solid state device to add, relative to the principle modal frequency, the sideband mode at the sideband modal frequency.

The mixer may further include a grating arranged to provide distributed feedback within the device; wherein the grating is provided as a series of a plurality of grating elements; and wherein the method may include electrically controlling the mixer to add, relative to the principle modal frequency, the sideband mode to the input light signal at any selected one of at least two respective sideband modal frequencies.

Any aspect or embodiment disclosed herein may be combined with any other aspect or embodiment disclosed herein unless the combination is expressly forbidden or is technically impossible. In particular, an aspect of the present invention provides a phase locked loop circuit which includes a THz mixer—the THz mixer may be a suitably configured mixer according to another aspect of the present invention which provides a mixer incorporating a grating providing distributed feedback within a solid state device formed of a material having a second or higher order susceptibility.

For example, the assemblies discussed in the first and second examples below may be modified to include the mixer of the third example below.

### BRIEF DESCRIPTION OF THE DRAWINGS

Embodiments of the invention will now be described by way of example with reference to the accompanying drawings in which:

FIG. 1 shows: (a) a schematic of a heterodyne detection scheme for THz emission according to an aspect of the present invention, (ESA—electrical spectrum analyser, DSO—digital sampling oscilloscope, OPLL—optical phase lock loop). (b) Optical spectra showing the primary NIR carrier, generated THz side mode (black) and NIR laser generating the heterodyne beat (red). (c) shows a sample heterodyne beat signal, where oscillations arise from the RF components in our detection circuit (d)&(e) shows current tuning in of the THz emission via both FTIR and heterodyne measurement techniques, illustrating the improvement in accuracy for the second;

FIG. 2 shows: (a) a schematic representation of our beat note detection setup (b) a sample waveform of the electrical beat note generated by our heterodyne system. By splitting the waveform into 50 ns windows and performing the Fourier transform (c) we can track the frequency of the generated RF with 20 MHz resolution;

FIG. 3 shows: (a) an illustrative current pulse applied to the QCL at 100 kHz with a 20% duty cycle, (b) the frequency of the beat note as a function of time, where the BN passes through DC at ˜250 ns, (c) fine tuning in the QCL with both (i) current, and (ii) temperature;

FIG. 4 shows: dispersion engineering in aperiodic gratings. a) shows an example aperiodic grating and its Fourier transform, b) shows grating reflectivity (i), group index (ii) and effective index (iii) for a uniform grating with a fundamental pitch Λ=14.2 um, n_{neff}=3.61 and Δn=0.3. Dashed lines mark the approximate laser mode positions from QCL 1 c) shows a schematic of the generation of sidebands by the QCL d) shows the change in PM frequency corresponding to a change in refractive index;

FIG. 5 shows discrete tuning of sidemodes on a NIR carrier a)-b) shows the THz emission of two QCLs milled with ADFB gratings (c) shows the experimental setup, where laser light is butt coupled into the optical cavity (d) shows sideband generation on the ADFB THz QCL laser (e)-(f);

FIG. 6 shows control of the phase matched frequency, the efficiency is defined as the sidemode power divided by the primary mode power, the spread of the data points is due to a combination of experimental inaccuracy and FP oscillation effects on both NIR pump and THz side mode (with representative error bars): (a) shows QCL 1 and (b) shows QCL 2;

FIG. 7 shows cavity dispersion changes through modal fine movement: (a) shows current based frequency tuning for QCL without a grating, (b) shows current driven frequency tuning for QCL 1 with an integrated aperiodic grating;

FIG. 8(a) shows a representative plot of the gain in an optoelectronic device, such as a laser, with two active regions;

FIG. 8(b) shows a representative plot of the change in filter response (strength) of an ADFB grating as a function of applied bias (0V, 1V and 5V);

FIG. 8(c) shows emission spectra for a dual gain device, where the plots top to bottom show:

the emission spectrum for a Fabry Perot (FP) device, the predicted filter response of the ADFB grating, and 3 pairs of plots for the emission spectrum of a suitable QCL incorporating the ADFB grating respectively at 0V, 1V and 5V;

FIG. 9 shows a pictorial representation of the variation in the filter response (right hand side) when the filter response of the grating elements (e.g. the voids provided by the grating) is varied (left hand side);

FIG. 10 shows an optical phase locked loop system according to an aspect of the present invention, incorporating a THz mixer according to an aspect of the present invention;

FIG. 11 shows alternative embodiments of the present invention, including on the left hand side an assembly including a transmitter and receiver arranged to transmit THz signals over optical fiber, and on the left hand side an assembly including a transmitter and receiver arranged to transmit THz signals over free-space;

FIG. 12(a) shows a layer of gate tuneable graphene on top of the ridge of a THz QCL, which is configured to act as a THz mixer according to an aspect of the present invention, (b) shows a suitable arrangement for mixing generated THz light with a telecoms laser incorporating the THz mixer of (a), and (c) illustrates how phase locked lasers can be used according to the present invention to transmit digital data at high bit rates;

FIG. 13 shows an example of a THz over fiber system incorporating a digital coherent transmitter for transmitting THz over fiber signals to a digital coherent detector, in accordance with an embodiment of the present invention; and

FIG. 14 shows an example of a digital coherent transmitter incorporating a mixer according to an aspect of the present invention, controllable to add multiple channels to an carrier signal to provide a multi-channel transmission and detection THz over fiber system.

### DETAILED DESCRIPTION AND FURTHER OPTIONAL FEATURES OF THE INVENTION

Before discussing exemplary embodiments of the present invention it may be instructive to explain the underlying principles of the present invention, which have allowed the present inventor to propose a novel mixer arrangements which provides the possibility to transmit THz over fiber.

Nonlinear Mixing Processes in Optics

When an electromagnetic wave (E) propagates it polarises (P) the medium it propagates through. Normally the amount the material is polarised is directly proportional to the applied electric field:

P=ε₀χE

Where x is the susceptibility of the material. This susceptibility is normally a constant with respect to electric field for most materials, which leads to normal light propagation. However, in nonlinear materials, this susceptibility is not a constant with respect to the electric field, and can be expressed as an expansion:

χ(E)=χ⁽¹⁾+χ⁽²⁾E+

This results in a polarisation vector P that is proportional to powers of the electric field. This results in the interaction of different electromagnetic waves propagating through the medium, generating new frequencies. To show this we will consider a material with a significant χ⁽²⁾ component, as this is the type of nonlinear process that we use in our experiments. If we assume that two waves are propagating such a nonlinear medium with frequencies ω_{NIR} and ω_{THz}, we can write the polarisation vector:

P=ε₀χ⁽¹⁾(e^{i(ω}_{NIR}^{t-k}_{NIR}^{z)}+e^{i(ω}_{THz}^{t-k}_{THz}^{z)})+ε₀χ⁽²⁾(e^{i(ω}_{NIR}^{t-k}_{NIR}^{z)}+e^{i(ω}_{THz}^{t-k}_{THz}^{z)})²+c.c.

The first term here is linear optics, and can be neglected. By expanding the square:

P=ε₀χ⁽²⁾(e^{2i(ω}_{NIR}^{t-k}_{NIR}^{z)}+e^{2i(ω}_{THz}^{t-k}_{THz}^{z)})+2e^{i(ω}_{THz}^{+ω}_{NIR}^{-k}_{NIR}^{z-k}_{THz}^{z)t})+c.c.

We get three new frequencies−ω_{NIR}, ω_{THz} and ω_{NIR}+ω_{THz}, and the complex conjugate provides a fourth frequency−ω_{NIR}−ω_{THz}. This is precisely how new frequencies are generated in a nonlinear optical crystal. However, both the frequency, and wavelength of the source and generated waves must be matched for the wave to be generated efficiently, which is called phase matching. This condition is provided by the following two equations

ω_{new}=ω_{NIR}±ω_{THz}

k_{new}=k_{NIR}±k_{THz}

or equivalently for collinear waves (the case considered here):

n(ω_{new})ω_{new}=n(ω_{NIR})ω_{NIR}±n(ω_{THz})ω_{THz}

The dependence on the refractive index of the nonlinear crystal puts huge constraints on what frequencies can be generated in a given nonlinear material

Phase Matching in THz Lasers

As discussed above, the primary issue for efficient nonlinear mixing is phase matching—which is controlled purely by the refractive index of the waves in the mixing process. This means that nonlinear mixing only works at specific frequencies in specific materials.

For example, for Gallium Arsenide (GaAs), the material that a THz QCL is typically made of, THz light happens to phase match with light in the near infrared. This arises from the specific refractive index dispersion of GaAs, which possesses a discontinuity due to phonon absorption. The exploitation of phonon absorption has been dubbed polaratonic phase matching by other groups.

Now if we wish to alter these phase matched frequencies we need to change the refractive index of one or more of the waves.

This can be done in bulk semiconductors by using resonant absorption effects or in waveguides by changing the refractive index of the guided mode. These methods work by changing the refractive index dispersion curve of one of the waves. However, crucially, both of these techniques are only useful for controlling the phase matched point for a single frequency. To elaborate, we could start with a nonlinear process where THz emission at a specific frequency phase matches with a single near infrared frequency. By using either of the aforementioned techniques we can change the refractive index of the THz wave, and hence alter the NIR frequency with which the THz emission matches. However, if we wanted to simultaneously control the phase matching of several THz frequencies, with several different NIR frequencies, neither technique would work. This is because conventional methods of altering the phase matched wavelength cannot change the refractive index independently for multiple, closely spaced frequencies. This is where hologram gratings (for example distributed feedback gratings) are especially effective.

Hologram Phase Matching

Hologram gratings possess multiple closely spaced reflectivity bands with a spacing that can be pre-determined during the design process.

The use of such gratings to engineer discrete emission from THz QCLs has been documented before.

What has not been documented is how the hologram grating alters the propagation of light across each reflectivity band. We have been able to show that the current tuning behaviour of the lasing in each mode is different, suggesting that they have different propagation properties or equivalently a different refractive index. To confirm this we have developed accurate transfer matrix techniques, and have been able to show that the refractive index varies across the hologram reflectivity bands. This variation in the refractive index can be exploited to alter the phase matching of several THz frequencies simultaneously—allowing multi-wavelength nonlinear devices. We have observed this modified phase matching directly in our experiments. Furthermore, by exploiting inverse design techniques, hologram gratings could be used for user specified multi-wavelength phase matching.

### FIRST EXAMPLE

This example will demonstrate that according to the present invention high-accuracy heterodyne detection of THZ radiation is possible by using existing telecommunication technologies is possible.

In particular, in this example, we will show an open-loop heterodyne technique using standard telecom optical fiber components for spectral characterization of THz semiconductor lasers, which allows the measurement of continuous modal tuning with sub-GHz accuracy and 20 dB dynamic range.

In this example it is not necessary for the mixer device (for example, a THZ Quantum Cascade Laser) to incorporate a periodic or aperiodic distributed feedback grating (DFB), although it may be preferred to do so in order to obtain the benefits of the DFB as described herein.

Introduction

The poor free space transmission of THz Quantum Cascade Laser (QCL) emission can be overcome through up-conversion to near infrared (NIR) frequencies by exploiting the nonlinearity of the laser cavity itself. This allows THz signals to propagate down an optical fiber (so called THz-over-Fiber) [1] and opens up the possibility of using advanced optical fiber technology to control and measure THz emission. In this paper we show how we can use an open-loop heterodyne technique [2], based on standard telecom optical fiber and radio-frequency (RF) components to characterize spectral emission from conventional Fabry Perot (FP) QCLs. We can detect the QCL linewidth, frequency and current tuning with sub-GHz resolution and 20 dB dynamic range in this un-optimized setup, comparable with measurements obtained by direct heterodyning at THz frequencies [3]. The measured heterodyne linewidth is significantly broadened from the intrinsic QCL linewidth due to both the free running operation of the NIR lasers and rise time effects inherent to pulsed operation of the QCL. We use this heterodyne technique to measure current tuning of the THz QCL, which can be compared with that measured by a Fourier transform infrared (FTIR) spectrometer. This technique could be extended to produce an all fiber phase lock loop for a THz QCL, allowing the realization of high speed coherent communication via a THz laser.

Device Fabrication, Characterization and Methods

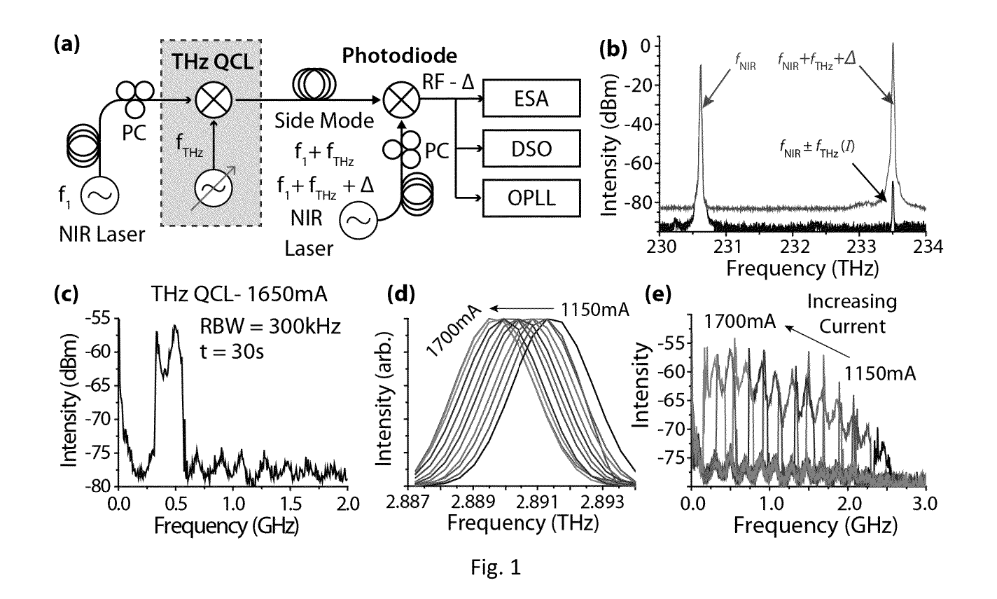

Terahertz QCLs based upon semi-insulating surface plasmon waveguides were fabricated from a GaAs/Al_{0.15}Ga_{0.85}As wafer, using a bound to continuum active region with integrated NIR guide layer [1] and operated in pulsed mode (10 kHz, 20% duty cycle) at 10K. THz laser emission was measured directly using a Bruker Vertex 80 FTIR with 2.1 GHz of frequency resolution. The scheme used for up-conversion THz to NIR frequencies and subsequent down-conversion to an RF beat note is illustrated in FIG. 1a. First, NIR light generated by a tuneable 1.3 μm external cavity laser was injected into the QCL waveguide via butt coupling single mode optical fiber to a QCL facet. The subsequent intracavity up-conversion of THz light to a telecoms side mode via nonlinear mixing with NIR light has been discussed in ref [1]. In brief the large χ⁽²⁾ nonlinear coefficient of the GaAs active region results in strong interaction between injected NIR light and generated THz light. Secondly, the anomalous dispersion of the Reststrahlen band in GaAs results in the phase matching between the NIR and THz waves (so called polaratonic phase matching). This means that NIR and THz light interact and mix efficiently inside the QCL cavity, producing NIR±THz side modes. The main NIR mode and generated THz side modes were collected from the other facet of the QCL using a second butt coupled single mode fiber, and measured using both a fast photodiode (Thorlabs DET08CFC/M) and an optical spectrum analyzer (Yokogawa AQ6370Z). A sample optical spectra is shown in FIG. 1b, showing both the NIR carrier and a THz side mode. In order to generate the heterodyne signal, light from a second 1.3 μm external cavity laser was coupled into the optical fiber after the QCL (see FIG. 1b). The heterodyne signal was amplified by a 20 MHz-3 GHz low noise amplifier (Minicircuits ZX60-3018G−S+), and then could be detected by an electrical spectrum analyzer (Keysight HSA N9344C).

Results and Conclusions

An example heterodyne RF spectrum is shown in FIG. 1(c). The frequency of this signal reflects the difference between the second NIR laser and the up-converted THz signal. The RF signal linewidth is a combination of the intrinsic linewidth and frequency jitter from each of the three lasers. For example, the 200 MHz heterodyne linewidth of the two free running NIR lasers contributes significantly to the measured linewidth, but results are still consistent with those measured directly in the THz [3]. We can use this characterization method to study the current driven continuous tuning properties of THz QCLs. Current tuning of THz QCLs is crucially important for producing tuneable sources of THz light, and although often attributed to Joule heating of the active region, the negligible temperature tuning of THz QCLs suggests that an alternative mechanism must be in play [4]. It has been suggested that in THz QCLs current tuning may be attributed to mode pulling from the effective gain shape [4], and using this accurate heterodyne method we can study this phenomena with sub-GHz frequency accuracy. In FIG. 1(d) we show current tuning as measured by the FTIR, where low resolution limits the capabilities of our characterization, and in FIG. 1e we show the equivalent tuning as measured by heterodyne detection. The range of current tuning for both methods are comparable (2 GHz measured by FTIR, 2.148 GHz measured by heterodyne detection), and follow the current driven movement of the gain peak in this active region design. The accuracy of this technique could be significantly improved by frequency locking the two NIR lasers to a stable reference. In conclusion we have developed and demonstrated the first open-loop heterodyne technique based on conventional fiber optic components for the detection of THz radiation. This can be used to study the properties of THz QCLs with high frequency resolution, and could be extended to allow coherent control and phase locking of the QCL source.

### SECOND EXAMPLE

In this example, we discuss how the present invention can be applied to a fiber-interfaced heterodyne system for time-resolved spectral characterization of THz quantum cascade lasers; for example, by exploiting the bias probe rise time it is possible to study the current dependent mode tuning with 50 ns temporal resolution.

In this example it is not necessary for the mixer device (for example, a THZ Quantum Cascade Laser) to incorporate a periodic or aperiodic distributed feedback grating (DFB), although it may be preferred to do so in order to obtain the benefits of the DFB as described herein.

Introduction

Time-resolved spectral investigation of THz Quantum Cascade Laser (QCL) emission is crucial for applications requiring high emission stability, such as coherent communications and spectroscopy. Earlier work has shown that it is possible to temporally resolve such spectral emission by heterodyning two THz QCLs on a whisker Schottky diode [1]. In this paper we up-convert THz signals to the near infrared (NIR) inside the QCL cavity [2] to demonstrate, to the best of our knowledge, the first fully optical fiber-interfaced communication system for the time-resolved heterodyne characterization of THz laser emission. The heterodyne waveform can be measured by oscilloscope and split into 50 ns time frames, each containing spectral information about the emission of the QCL, which is extracted via a Fourier transform. By exploiting standard fiber optic communication technology, this system is more compact, cost-effective and -flexible than working directly in the THz, and could be used to demonstrate coherent on-chip signal processing and transmission via THz QCL.

Device Fabrication, Characterization and Methods

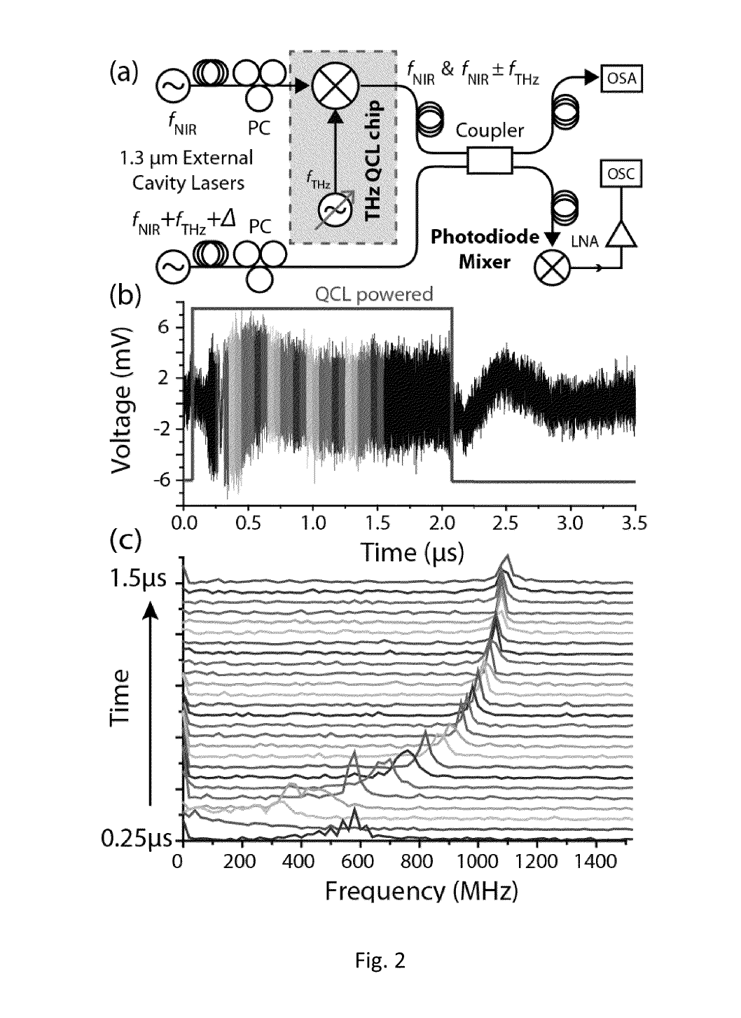

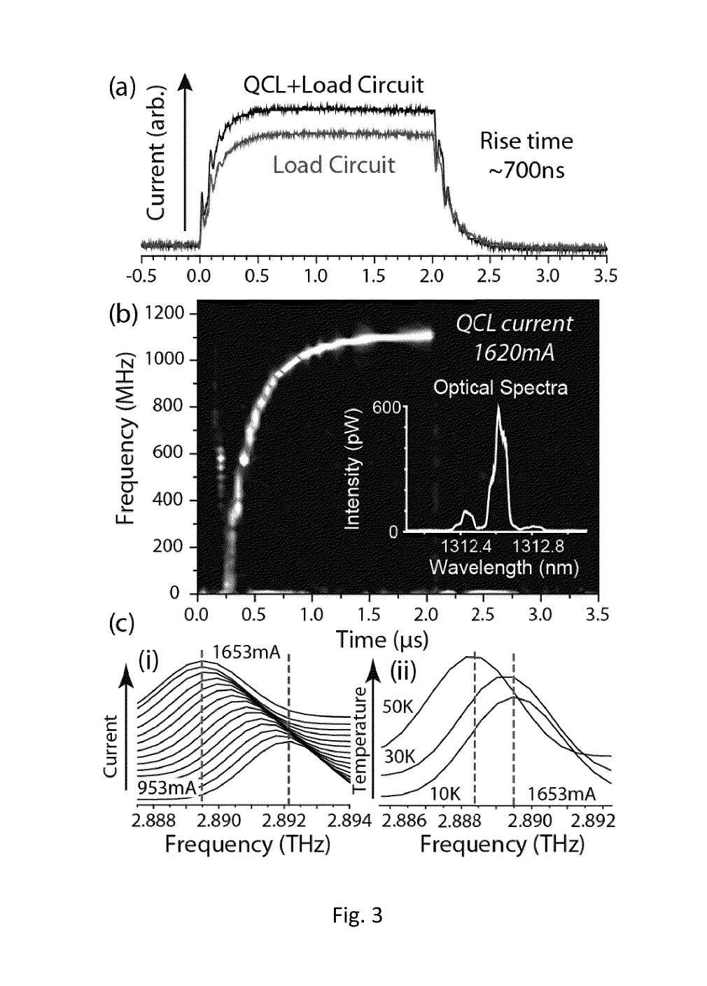

Terahertz QCLs based upon semi-insulating surface plasmon waveguides were fabricated from a GaAs/Al_{0.15}Ga_{0.85}As wafer, using a bound to continuum active region with integrated NIR guide layer [2]. THz laser emission was first measured directly using a Bruker Vertex 80 FTIR. The THz QCL was biased using a pulse generator running at a variety of currents and repetition rates at 15K. This bias circuit provides a rise time delay of ˜700 ns measured at room temperature using a high speed current probe (see FIG. 3a). The scheme used for generation of THz side modes and subsequent measurement of a radio-frequency (RF) beat note is illustrated in FIG. 2a. First, NIR light from a tuneable 1.3 μm external cavity laser was injected into the QCL waveguide via butt coupling single mode optical fiber to a QCL facet. The subsequent intracavity up-conversion of THz light to a telecoms side mode via nonlinear mixing with NIR light has been discussed in ref [2]. The generated THz side modes were collected from the other facet of the QCL using a second butt coupled single mode fiber, and measured using both a fast photodiode (Thorlabs DET08CFC/M) and an optical spectrum analyzer (Yokogawa AQ6370Z). To generate the heterodyne signal, light from a second 1.3 μm external cavity laser was injected into the fiber via a coupler after the QCL. The generated RF beat was amplified using a 20 MHz-3 GHz 22 dB low noise amplifier (Minicircuits ZX60-3018G−S+), and then detected by a Keysight Infinium MSO9104A oscilloscope. A sample waveform of the RF beat note generated between the THz side mode and the second external cavity laser is shown in FIG. 2b, with the current pulse illustrated on the figure. This waveform was broken down into separate 50 ns frames, and a Fourier transform was performed frame by frame to analyze transient frequency variations in the RF beat note (FIG. 2c). The frequencies of both NIR lasers do not vary significantly over the time period of the pulse (2 μs), so changes in beat note frequency can be attributed to the QCL emission.

Results and Conclusions

An indicative heterodyne measurement of QCL emission when driven by a 2 μs long current pulse is presented in FIG. 3b. After a short delay for the current to rise above threshold, lasing begins and there appears to be significant frequency tuning with a net tuning range of at least 1.7 GHz, after which the frequency stabilizes as the driving current reaches close to its maximum value. As expected, the timescale of this frequency tuning is comparable with that of the applied current pulse (FIG. 3a) passing through the QCL, suggesting that this tuning can be attributed to the shape of the current pulse. This transient frequency tuning (>1.7 GHz) is similar to the current tuning measured via the FTIR (2.6 GHz shown in FIG. 2c(i)). Current tuning is frequently attributed to Joule heating of the active region, as time resolved photoluminescence measurements of QCLs suggest that the active region temperature may increase by as much as 10K across pulses of the order of 2 μs long [4]. However, characterization of the QCL emission by FTIR (FIG. 3(c)(ii)) shows that only 1.2 GHz of frequency tuning could be achieved using as much as 40K variation in laser temperature. This suggests that the >1.7 GHz transient tuning cannot be attributed to Joule heating. We can instead attribute this current tuning to the gain properties of the active region [3]. Inter-subband transitions are intrinsically fast, any variations in driving current will rapidly change the gain shape of the QCL. Variations in this effective gain profile will alter the modal mode pulling and lead to rapid frequency tuning, as observed in this experiment.

In conclusion, we have developed the first fully optical fiber compatible heterodyne technique for the time-resolved measurement of THz QCL emission. This system could be used for coherent communication experiments using THz QCLs. We observe that when a THz QCL is operated with non-ideal current pulses there is significant modal tuning, attributed to variations in the gain profile with driving current.

### THIRD EXAMPLE

Nonlinear optical phenomena within THz Quantum Cascade Lasers offer a route to achieving transmission of THz frequencies long distances (ToF)¹ and ultra-fast² frequency switching³ across conventional optical communication fiber. Although it has been possible to enhance the nonlinearity of these devices³, it has not been possible to improve THz emission⁴ and nonlinear optical effects simultaneously and monolithically. In this example, we show that holographic photonic band gap engineering in finite one dimensional aperiodic gratings can electronically control both the emission and dispersion properties of laser modes.

This allows us to simultaneously introduce discrete electronic tuning, and control the nonlinear phase matching process within e.g. a QCL. As explained, such control of laser emission and nonlinear processes are useful for frequency switching³, THz laser based communications, and nonlinear generation of THz radiation^{6,7}.

The one dimensional grating with a single photonic band gap (PBG) is an integral tool in photonic engineering, used for highly frequency selective mirrors, lasers and waveguides (REF).

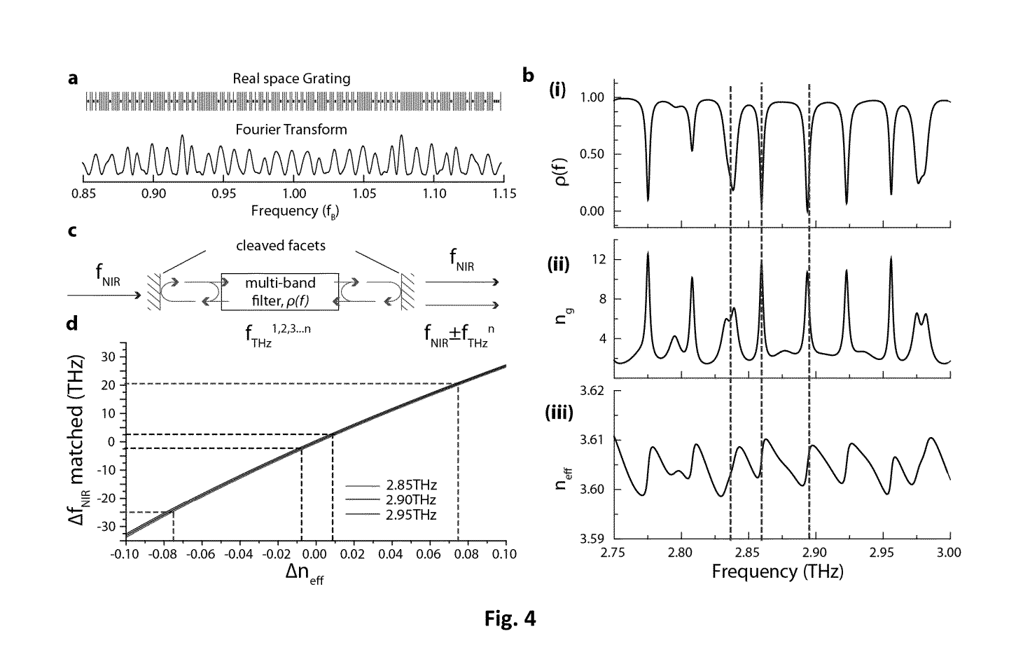

Non-periodic (aperiodic) gratings⁸ and crystals⁹ offer much more spectral flexibility for multi-wavelength applications, albeit at the cost of real space complexity. By using holographic inverse design methods^{10,11} it is possible to engineer aperiodic gratings with user defined reflectivity response (FIG. 4a).

To understand the finite dispersion properties of these complex photonic structures we can use the grating reflection and transmission coefficients¹²⁻¹⁵. For example a periodic grating with a single reflectivity band has an incomplete photonic band gap, with associated changes to the photon dispersion at the band edge¹².

In analogy to this single band gap in periodic structures, aperiodic gratings with multiple reflection bands (FIG. 4b(i), calculated via transfer matrix techniques possess multiple incomplete band gaps. At the edge of each of these reflection bands the changes to the photon dispersion lead to low group velocity and changes to the wavevector of light (see FIG. 4b(ii)/(iii)). This effect can be interpreted as a direct consequence of causality and the Kraemers Kronig relations^{14,15}. It has already been shown that the low group velocity at the photonic band edge can be used to produce a laser which emits on one or more band edge modes¹⁶ (new OE too). In this paper we use changes to the wave-vector associated each band edge lasing mode in order to control the nonlinear phase matched frequency for each laser mode.

Phase matching is one of the primary restrictions on the flexibility of nonlinear optical systems. It requires both the frequencies and the wavevectors of the pump, idler and signal waves to be equal in order to get constructive energy transfer into the signal wave¹⁷. Controlling the wavevector (or equivalently refractive index) of the idler wave using waveguide engineering¹⁷ or PBG engineering^{12,18,19} allows control this phase matched frequency. This is distinct to standard quasi-phase matching techniques; whereby a variation in the nonlinear permittivity is used to change the phase of the generated wave^{20,21}. Hologram engineering gives control of the effective index for several closely spaced band edge modes in aperiodic gratings, changing their respective phase matched frequencies (see FIG. 4b(iii)). This suggests that we could achieve a discretely tuned laser where each mode possesses a slightly different refractive index. Discrete electronic tuning using an aperiodic grating^{11,22} and nonlinear mixing with NIR light²³ has already been independently realised in THz Quantum Cascade Lasers (QCLs). As such, by combining these two technologies we can produce discretely tuneable sidebands on a NIR carrier with wide phase matching.

In order to estimate the degree of change to the phase matched frequency achievable through PBG engineering we can refer to FIG. 4b(iii), where a change of around ˜0.01 is achievable over 50 GHz. This corresponds to a shift in phase matched frequency of the order of 5 THz, much larger than that achieved through the index of bulk GaAs. Through engineering our grating design it would be possible to enhance the index perturbation up to ˜0.15, corresponding to a phase matched frequency shift of 50 THz. With a combination of discrete mode tuning, and 50 THz of phase matching bandwidth (a full communication band) such THz QCLs are highly appealing for communications⁵. This technique to produce discrete tuning and phase matching is not limited to THz QCLs, and could be used for generation of THz by phase matching in two waves in the MIR^{6,7}. We will now demonstrate that the proposed control of both phase matching and discrete tuning can be realised in THz QCLs.

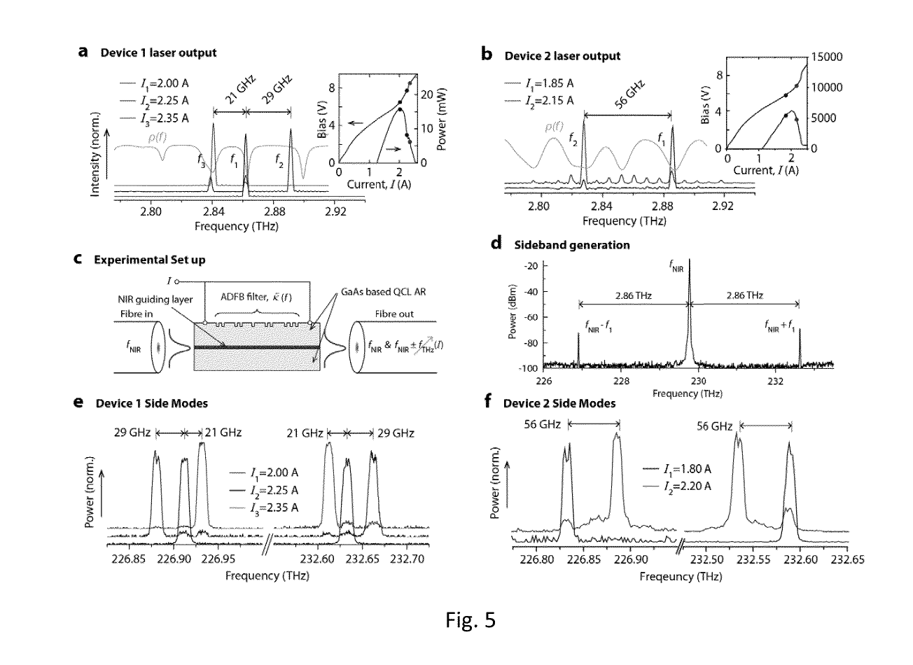

Lasers with a single metal waveguide of ridge width 200 μm were defined in a GaAs/Al_{0.15}Ga_{0.85}As wafer by wet etching and then subsequently cleaved into 5 mm Fabry Perot (FP) cavities. Aperiodic gratings, using the design of FIG. 4a, were introduced to the waveguides of two lasers by the use of focussed ion beam milling, etched through the top metallic layers of the waveguide (although periodic gratings could have been used). Throughout the experiments devices were driven in pulsed operation at a 10 kHz repetition rate. Devices were characterised both before and after the introduction of the grating using a FTIR and calibrated internal thermopile detector. FIGS. 5a and b shows the THz emission properties of QCLs 1 and 2 both before and after the introduction of the grating respectively. The introduction of the grating acts to change the FP multimode emission properties of the THz QCL 1 into three spectrally pure modes, selected through variations to the QCL driving current (for full data see supplementary 4). In QCL 2 the grating has a reduced effect on the laser emission, resulting in two dominant modes but generally multimode emission. The difference in spectral properties between devices is attributed to different grating depths (see S5), which leads to a change in refractive index contrast. The high spectral quality of QCL1 suggests that the grating coupling constant is relatively high, which suggests the index values in our numerical calculations are reasonable²⁴. After characterisation of the THz emission of these lasers, the mixing properties of each mode were investigated by injecting and extracting ˜1.3 μm light from the QCL cavity (FIG. 5c). The time averaged spectral properties of each NIR sidemode was investigated using an optical spectrum analyser, collecting both primary and side modes simultaneously (see FIG. 5d). For both lasers the frequencies of each of the THz modes are up-converted to the near infrared, with mode line-width limited by the resolution of the OSA (FIG. 5e and f). This shows that the discrete tuning warranted by an aperiodic grating can be use discretely tune NIR side mode generation in a THz QCL through driving current.

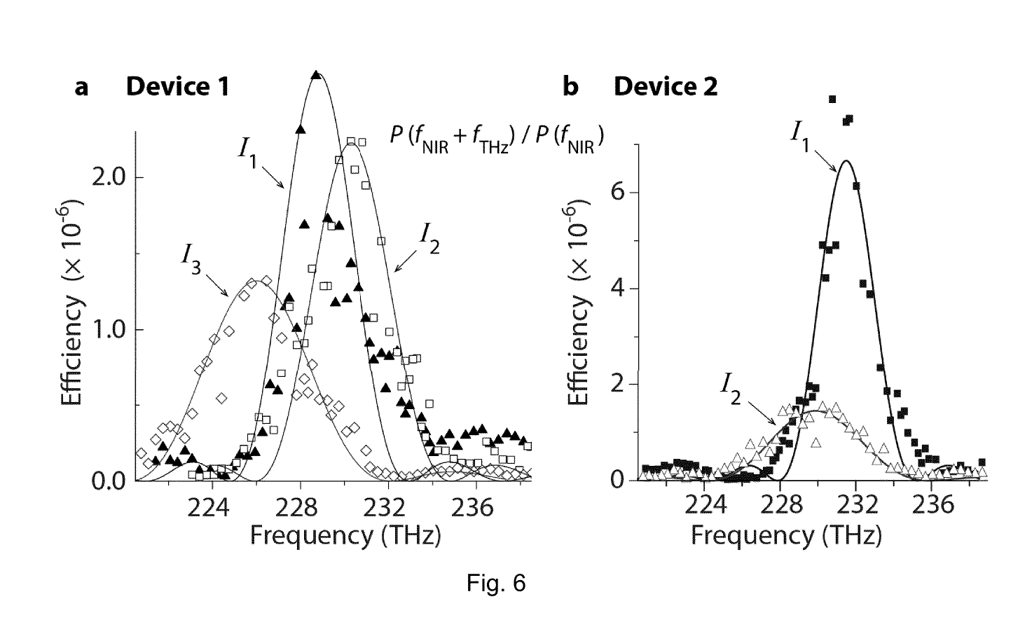

In order to investigate the phase matching properties of each THz side mode the power of the high frequency side mode was measured as the near infrared carrier frequency was varied. The efficiency curves for the modes in QCL 1 and 2 are plotted in FIGS. 6a and b respectively. The values of efficiency in this work are consistent with those in earlier work, with small reductions owing to pulsed operation of the QCL. In order to determine the phase matched point we have fitted the data with a sinc function, where the peak value is at the phase matched frequency. This data reveals that each mode in both lasers have distinct phase matching curves. As the frequency separation of the highest and lowest THz modes are similar for Device 1 (mode 3 and mode 2) and Device 2 (mode 2 and 1), we can also compare the range of tuning to the phase matched frequency. For Device 1 we have ˜4.3 THz of tuning, whereas for Device to we have ˜1.2 THz of tuning. Both these values are more significant than could be expected for bulk GaAs (˜0.5 THz), suggesting that the introduction of the grating has altered the phase matching. The larger 4 THz tuning range from device 1 is due to the stronger grating introducing a larger change to the effective index and agrees with the numerical results in FIG. 4. This shows that it is possible to change the phase matched frequency of several discretely tuned modes using an aperiodic grating. Furthermore this demonstrates that an aperiodic grating can be used to alter the dispersive properties of a laser cavity.

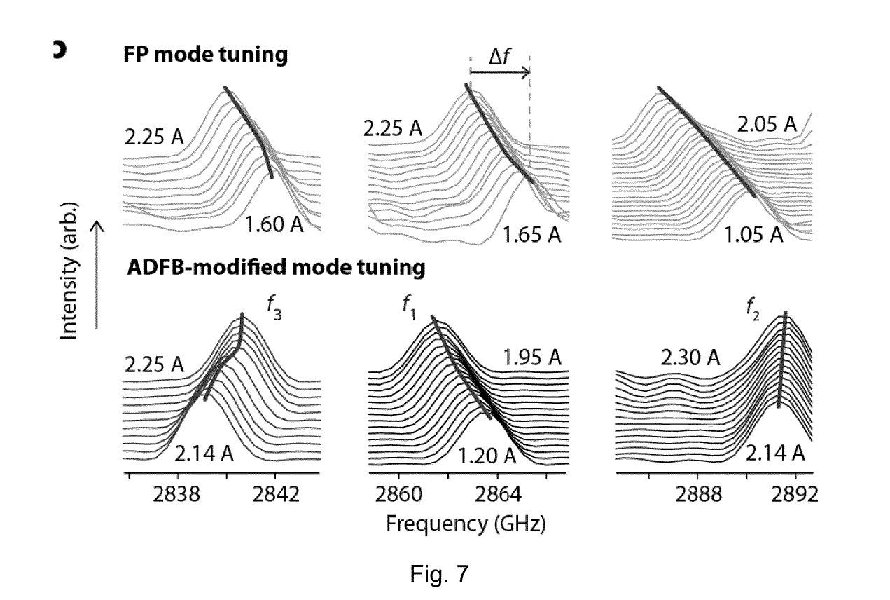

In order to confirm that the dispersion properties of the THz modes are attributed to the introduction of the grating, we can study the current tuning properties of each mode. The exact frequency positioning of each THz laser mode arises from the standing wave solutions of the cavity; which require that the round trip phase shift must be zero. This phase shift will be directly proportional to the refractive index of the cavity for each laser mode. If the driving current of the QCL is varied, a combination of gain movement and heating effects lead to changes in the effective index, and hence this matched frequency. If we have changed the dispersion of the cavity we will have introduced an equivalent change to this frequency, leading to changes to the fine tuning properties. In FIG. 7 we show the fine tuning properties of the laser modes both (a) before and (b) after the introduction of the grating for Device 1. The fine tuning of each laser mode before grating introduction is uniform—red shifting as driving current increases. After the introduction of the grating the modes remain unchanged, stop tuning or reverse tuning direction (modes 1, 2 and 3 respectively), suggesting the dispersion of each mode has significantly changed²⁵. This provides indirect confirmation that the refractive index of each THz mode has changed from the introduction of the grating.

Here, we have demonstrated the use of an aperiodic grating to simultaneously control the emission frequency and nonlinear properties of a QCL Through the use of numerical simulations we have shown how an aperiodic grating allows both band edge lasing and engineered dispersion properties of a laser. We have shown that these effects could be used to engineer the NIR phase matched frequency of a THz QCL by up to 50 THz—a full communication band.

By integrating an appropriate aperiodic grating into two QCLs, and mixing THz with telecoms light we have been able to demonstrate discrete tuning of a THz side mode. We have then shown that each mode possesses a different refractive index, leading to unique phase matched frequencies for each side mode. This technique of simultaneous discrete tuning and phase matching could be applied to a number of applications, such as generation of THz waves by MIR QCLs⁶, multi-wavelength frequency converters³, and WDM on QCLs⁶.

Although this example has been described with reference to an aperiodic distributed feedback grating (ADFB grating), the use of a periodic grating (DFB grating) is also covered by the present invention. When an aperiodic grating is used, it is possible to switch between at least three sideband modes. However, when a periodic grating is used, it is possible to switch between two sideband modes, because a periodic grating is also able to alter the dispersive properties of the laser cavity.

Discussion

The present invention allows direct implementation of coherent photonic technology, based on that used for optical communications, into a switchable THz over Fiber (STOF) system.

The present invention provides a compact, coherent, tunable THz QCL system with direct fiber-in and fiber-out capability and the demonstration of modulation at frequencies well in excess of standard. At the heart of an STOF system according to an aspect of the present invention is an optical phase-locked loop (OPLL).

The optical phase-locked loop (OPLL) is a well-established technology that can be used for a variety of applications, such as for realizing precise frequency measurement equipments (THz spectrum analyzers), signal sources of standard frequency (THz clocks), and accurate, tunable, single frequency signal generators (THz synthesizers).

An OPLL, in conjunction with an RF signal synthesizer, can be used to precisely and linearly control the frequency of a graphene-plasmon enhanced THz aperiodic DFB QCLs. Monolithic integration along with custom built electronic circuits can enable such OPLL for heterodyne locking, realizing low linewidth, and digitally synthesized THz dynamic range sources.

Within an OPLL, a control circuit compares the unstable laser with a stable reference. By using a combination of feedback techniques, this control circuit can reduce frequency jitter and line width of semiconductor laser to the sub-hertz level. The most important component of phase locking is establishing an error signal—which determines the deviation of the laser frequency and phase from the optical reference. Achieving such signals for THz QCLs is particularly challenging. This is primarily because such error signals are typically at radio frequencies, a few GHz, and high speed detectors in the THz (such as hot electron bolometer) are expensive. Ideally mature optical fiber technology is used in order to measure and use such error signals. To do this THz light needs to be converted to optical frequencies, and this is achievable by using nonlinear processes e.g. within QCLs. Once up-converted we can then generate an error signal between this up converted THz mode, and a standard NIR optical reference.

This is where we can use our well-developed SToF technology to generate switchable THz sidebands on a single mode NIR laser.

This side mode contains all of the properties of the QCLs THz emission, plus the properties of the single mode NIR laser. By coupling this side mode with a second NIR laser onto a fast photodiode we can generate a beating signal between the two frequencies. This radio frequency signal (typically a few GHz) can be measured with an electrical spectrum analyser, and possesses phase and frequency information about all three lasers. This beat signal could then be used to generate an error signal and a phase locked loop for the QCL using appropriate electronics and stable NIR lasers. In order to verify that this method can be used to generate a beat signal, recently we have conducted a number of experiments. This has led to the first detection of a beat signal from a THz QCL using standard telecommunications components, as discussed above.

In an example, the present invention provides for a STOF system with tunability around the mainstream 1.3 μm and 1.5 μm telecoms wavelength, that is capable of receiving, transmitting and passing on digital data at THz data rates in a single wavelength within a WDM (wavelength division multiplex) system.

A basic discussion of how an OPLL can be used in accordance with the present invention is presented here:
After the RF heterodyne beat note is generated on the basis of the output signal from the THz mixer (typically the QCL structure), it is fed into a phase locking control circuit.
This phase lock circuit preferably has five key components: a frequency divider, a stable electronic reference, a phase frequency detector (PFD), an optional loop filter and a control circuit for the QCL.
   The frequency divider acts to reduce the frequency of the beat note to that of the electronic reference (divide by N).
   The PFD produces an error signal by comparing the down-converted beat note and the stable reference.
   The loop filter (LF) is typically a low pass filter which removes any unwanted high frequency components from the error signal.
   The control circuit converts this error signal into a current which can be applied to the QCL to control the frequency of the sideband mode frequency.
   For example, the variation in current will alter the frequency of QCL emission and correct any phase and frequency errors.

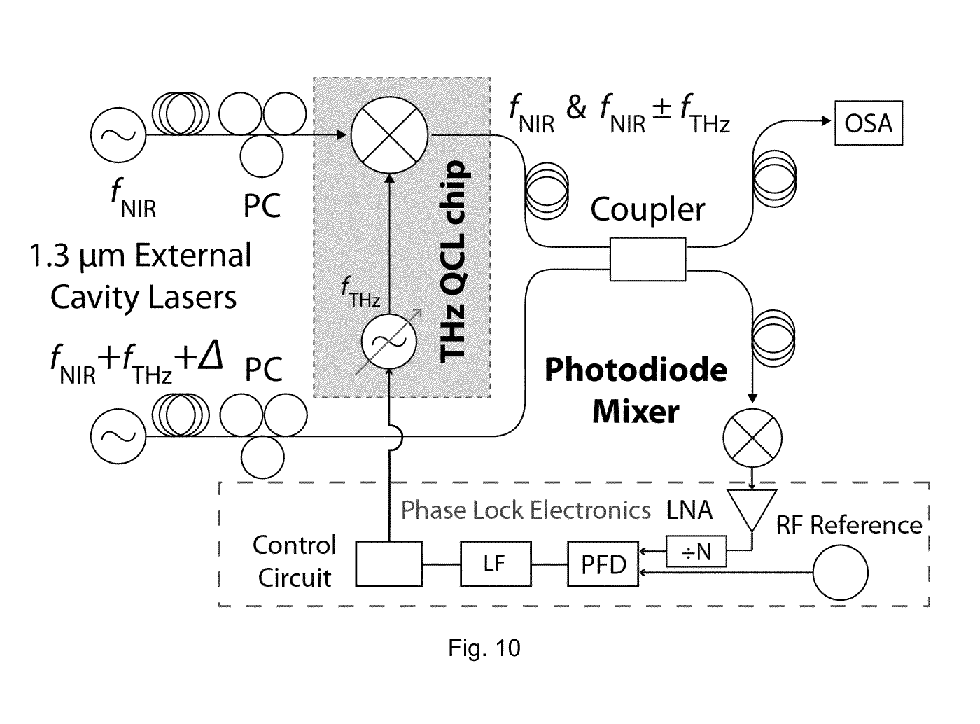

An illustrative schematic is shown in FIG. 10.

As will be appreciated, the present invention utilizes nonlinear mixing to provide the first fully optical fiber-interfaced communication system for the heterodyne detection of THz laser emission. According to the present invention it is possible to generate a radio frequency signal containing the full frequency and phase information about the THz laser emission—and thus this can be applied to coherent communication to allow THz information to be transmitted over fiber, for example.

However, a technical challenge for using coherent techniques is that they require narrow linewidth optical sources. As free running lasers possess linewidths in the order of 10's of MHz, they are inapplicable for use in coherent systems. To overcome this problem the present inventors propose to use optical phase locked loops—whereby the laser is stabilised to an optical reference.

To put the benefits of the present invention into context, hitherto if we wished to realise coherent communication in the THz using a QCL then we would require a THz reference with very high absolute frequency stability, which is very expensive and typically requires very bulky equipment (e.g. meters). Such a system would be completely inappropriate for most real life communication scenarios.

However, by using THz over Fiber and communications technologies we can overcome this limitation.

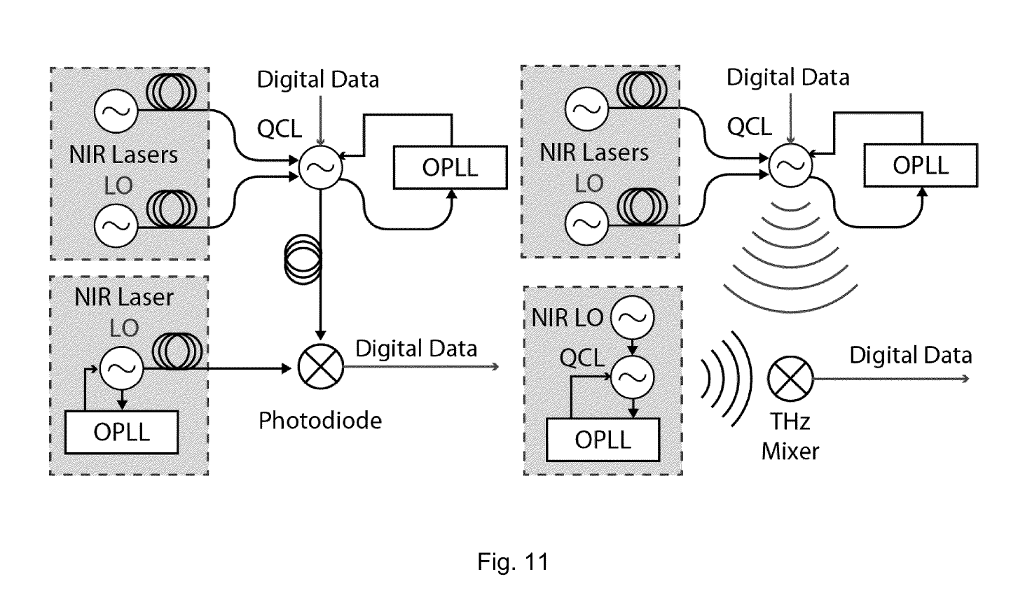

In the proposed ToF setup THz radiation is up-converted to a telecoms sideband so telecommunications lasers can be used to phase lock our QCL without the need for expensive THz components. This system could be used for conventional coherent communication on fiber—where the sideband acts as the coherent carrier for data, and we use a conventional coherent receiver (see FIG. 11 left hand side).

However it could also form the backbone for both a coherent transmitter and a coherent detector in a free space THz transmission system (see FIG. 11 right hand side). By mounting some additional data onto the QCL we can achieve a coherent transmitter. A second phase locked QCL then acts as the LO for the coherent detection of THz using some fast detector—such as a whisker Schottky diode.

Terabit coherent communication using THz QCLs

The present invention is able to provide single channel or multichannel THz over fiber data links.

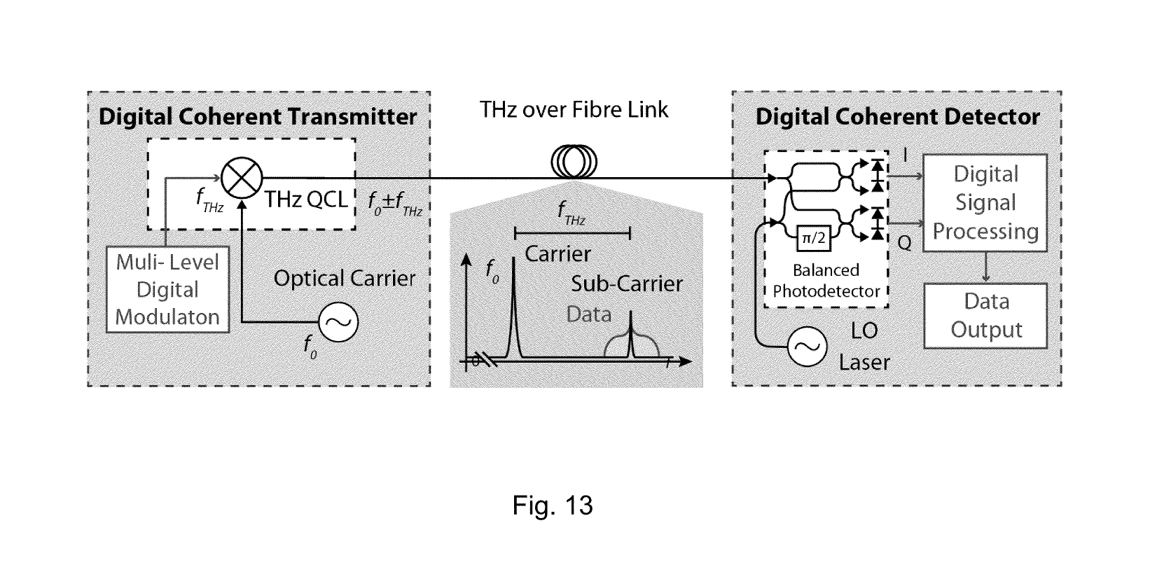

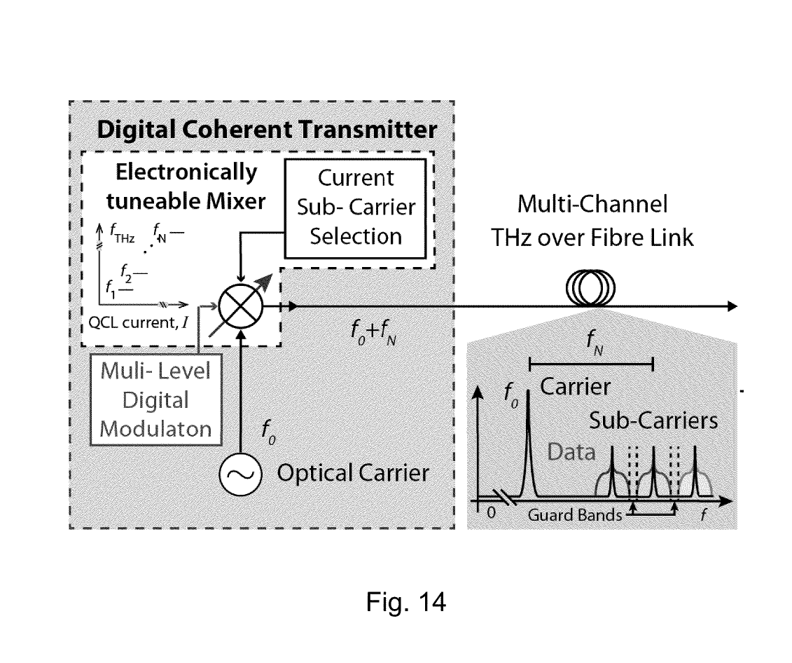

For example, a heterodyne Terahertz over Fibre photonic system locked to a microwave reference can act as a coherent transmitter for a route towards a >100 Gb/s telecoms system. Such a system may generally resemble the arrangement shown in FIG. 13 for example.

In the coherent transmitter, digital data encoded in complex modulation formats (e.g. quadrature amplitude modulation or QAM) for directly modulating the QCL, leading to >1 Tb/s data encoded on the coherent THz sub-carrier channel is achievable. The coherent transmitter may include a DFB or ADFB grating for example.

Coherent detection of the transmitted data, so as to extract the phase information of the signal can be achieved by using a double balanced homodyne receiver, as shown in FIG. 13 for example.

Furthermore, high-speed digital signal processing (DSP) can be used for retrieving the complex amplitude of the optical carrier from the homodyne-detected signal, while bit-error rate measurements may be done offline. By using advanced DSP methods on the data signals we can compensate for distortions, critical for the achievement of ultra-high bandwidth signals. The post-signal processing functionality as provided by the digital coherent detector is significant, any kind of multi-level modulation format can be introduced by using the coherent receiver.

The output of the detector is a time domain signal with ‘complex’ amplitude, obtained in the baseband, as follows

Eₛ(t)e^{j{φ}^{ₛ}^{(t)+φ}^{ₙ}^{(t)}}

In order to obtain the phase fluctuation φₛ(t), we need to achieve phase-locked condition [φₙ(t)=0]—this means local oscillator (LO laser) phase tracks the THz sub-carrier phase. It can be achieved either by using OPLL or by means of DSP.

We can also extend the complex modulation formats (16 QAM or higher) into multiple coherent THz sub-carrier channels by exploiting periodic and aperiodic DFB (ADFB) mixer technology mentioned earlier.

An aperiodic DFB grating produces discretely tuneable emission from a THz QCLs, each of which could act as a current selected communication band. Each band would be capable of carrying data of a bandwidth given by the spacing of the modes. This would allow for switchable channel multiplexing using only a single laser source.

An ADFB allows for two, three or more channels to be employed. A DFB will typically allow for two channels to be employed.

Adjustment of Pumping Current to Switch Between Sideband Modes

For example, the present inventor has explained in WO2013/024294 how the response of an ADFB grating within a QCL can be controlled by adjusting the pumping current, such that the output frequency at which the laser emits radiation is determined by the magnitude of the pumping current. In this publication, the laser may comprise a power source adapted to provide said pumping current, the power source being controllable to adjust said magnitude to select the output frequency at which said radiation is emitted.

As the laser comprises an active region of semiconductor material, and the grating elements are arranged to interact with radiation propagating along said active region. Thus, the present invention can be realized by adjusting the pumping current, to switch between sideband modes, in accordance with the present invention.

Use of Graphene to Switch Between Sideband Modes

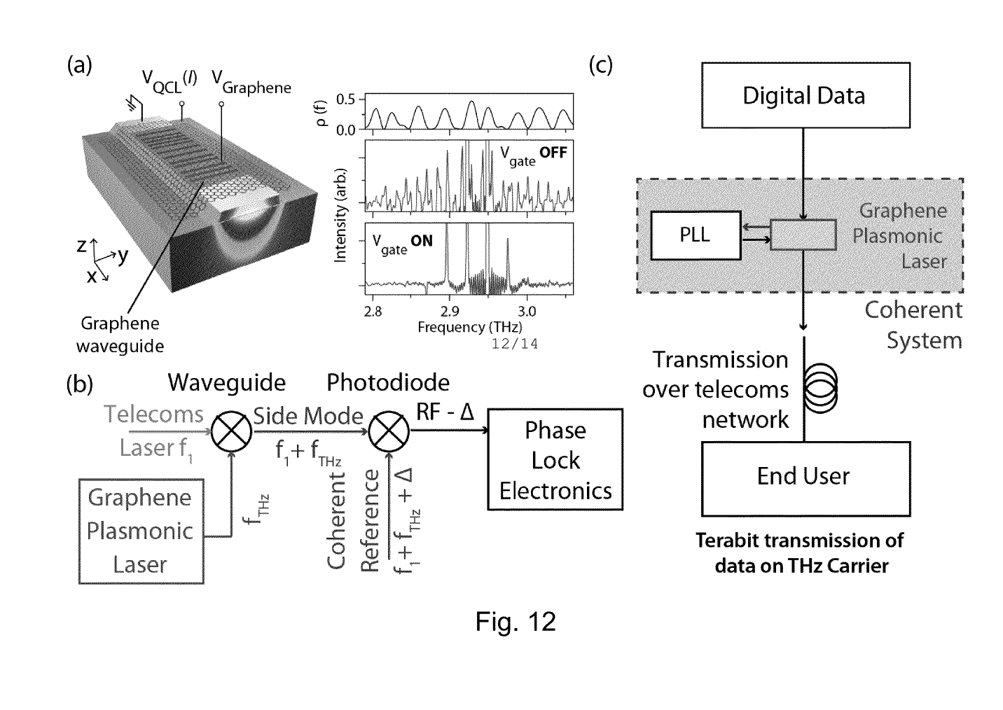

According to aspects of the present invention, graphene can been used to modulate the response function of the ADFB within the waveguide structure, for example within the QCL structure. A suitable structure for a graphene enhanced ADFB controllable THz QCL is show in FIG. 12(a). By adding a layer of gate tuneable graphene on top of the ridge of a THz QCL (incorporating the ADFB) the present inventor has been able to demonstrate voltage tuneable emission from a THz QCL, by controlling the voltage applied to the graphene film.

By exploiting the range of tuning achievable using a Graphene Plasmon enhanced waveguide we can lock the TQCL to a range of frequency offsets, continuously tuning the QCL whilst maintaining a narrow line width from the OPLL system.

This section will help to demonstrate how graphene is usable to control the distributed feedback response of the ADFB within the waveguide structure.

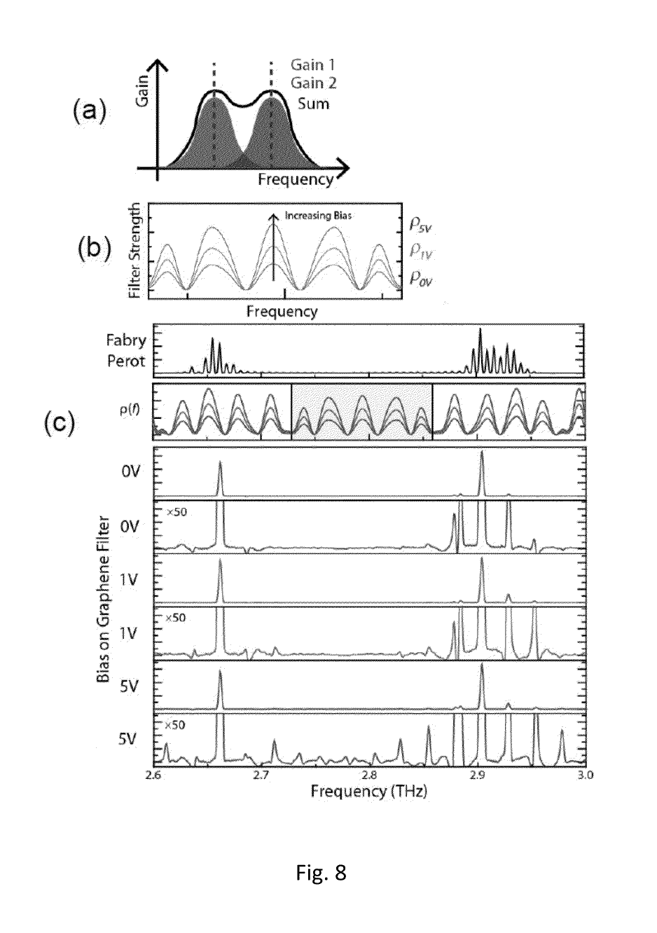

A THz QCL using semi-insulating SP-waveguides (160 um wide, 6 mm long) was fabricated from a GaAs/Al_{0.15}Ga_{0.85}As heterostructure with two bound-to-continuum active regions providing simultaneous emission at ˜2.65 and 2.9 THz. The general structure of the device is shown in FIG. 12(a). The tunable emission of such a structure is shown schematically in FIG. 8(a) for example, in which there is shown the gain spectrum for a material used in the structure.

The ADFB grating was introduced into the top layers of the laser waveguide using focussed ion beam milling (FIB). The device was then characterised in pulsed operation (10 kHz pulses at 1% duty cycle) at 10K using a FTIR spectrometer and Bolometer detector.

By adjusting the V_{QCL} across the QCL structure, the emission spectrum of the QCL can be controlled, i.e. tuned, as described in Applied Physics Letters, 102, 181106 (2013), the entire disclosure of which is incorporated herein by reference.

After initial device characterisation, a large area high quality, monolayer (up to 99% by area) CVD graphene was transferred as an overlayer to the ADFB grating.

Then, in order to be able to control the Fermi energy of the graphene layer an electrochemical top gate was overlaid on the graphene layer as described above. A bias can then be applied to the graphene across the electrolyte, to be varied from 0V to 5V, past the breakdown point of the electrolyte.

Results for the device are presented in FIG. 8(c). The top Fabry Perot plot shows the emission spectrum from the device prior to FIB patterning to introduce the ADFB grating. The next plot, labelled p(f) shows the predicted filter response of the patterned ADFB grating.

Then there are three pairs of plots, respectively showing the emission spectrum of the ADFB grating waveguide with graphene applied, and with a gate bias of 0V, 1V and 5V. Each pair of plots shows both the emission spectrum and a ×50 closeup of the emission spectrum.

As can be seen increasing the gate bias (from 0V to 1V to 5V) on the graphene results in the laser emission becoming more multimode. As will be appreciated the lasing modes are located exactly on each of the filter bands present in the grating.

It is therefore suggested that in this device the application of the gate bias to the grating significantly increases in strength the filter response of the grating. This is shown figuratively in FIG. 8(b).

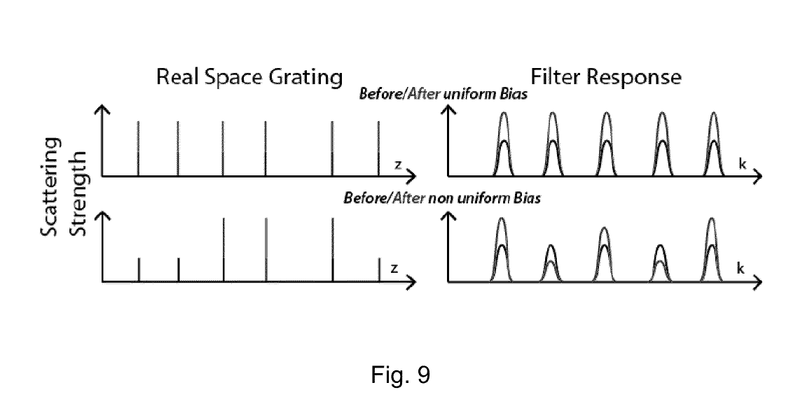

FIG. 9 provides a brief figurative explanation of the way in which the the spectral output of a suitable waveguide can be tuned using an aperiodic (or periodic) grating, and thus can be used in a THz mixer according to the present invention to permit selection of the sideband mode frequency.

The “real space grating” on the left hand side is representative of a real space arrangement of grating slits, or voids. As is known, the grating slits provide scattering sites for the radiation propagating in the waveguide.

The y-axis of each plot on the left hand side is indicative of the scattering strength of each slit, or void. So, we can say that the top left plot is representative of the scattering strength of an ADFB grating with a graphene layer under uniform bias. Whereas the bottom left plot is representative of an ADFB grating with a graphene layer under non-uniform bias, i.e. the graphene layer in the first, second and sixth slits, or voids, is under a different bias to the graphene layer in the third, fourth and fifth slits, or voids. As explained above, the effect of biasing the graphene differently results in different scattering strengths or effects, and thus will affect the emission spectrum of the waveguide.

This is represented on the right hand side of FIG. 9. In the top right plot, the filter response provides a series of uniform peaks in in k-space. Whereas, in the bottom right plot, the filter response provides a series of non-uniform peaks in k-space.

Thus, the filter response for the grating having the non-uniform biased graphene layer(s) will result in a different emission spectrum to that of the uniformly biased graphene layer(s).

Indeed, by biasing the graphene layers in the first, second and sixth voids suitably, the scattering strength of those voids could be “turned off” completely, resulting in a very different filter response.

Thus, according to the present invention by suitably biasing the graphene layers respectively provided in the voids of a grating having a plurality of voids, the filter response of the grating is fully controllable to tune the spectral output (emission spectrum) of the waveguide, such that it is possible to switch between the sideband modes applied to the output signal.

It is to be noted that the graphene layers respectively provided in the voids may be portions of a single graphene film, e.g. overlaid on the grating and arranged to span the respective voids.

The independent control of the graphene layers in the voids may be achieved by effectively pixelating the gate contact overlaid on the graphene (and/or indeed pixelating the graphene itself). In other words, respective bias gate pads may be provided for sets of graphene layers respectively provided in the voids (slits) of the grating. Each set of graphene layers may comprise one or more graphene layers.

By the application of suitable bias voltages to the respective bias gate pads, the respective graphene layers provided in the voids (slits) can be controlled to modify the filter response of the grating to tune the spectral output (emission spectrum) of the waveguide, thereby allowing the sideband modes to be switched.

In essence, the present inventor has demonstrated electrically gated graphene control of the filter response of the grating, provided on the waveguide, sufficient to significantly affect the emission spectrum of the waveguide to be able to add a sideband mode to a NIR signal propagating in the waveguide at a selected frequency.

In other words, incorporating a suitable THz mixer based on the tuneable THz QCL of e.g. FIG. 12(a) into a circuit such as that shown in FIG. 12(b), the THz light generated within the THz QCL can be mixed with light from a telecoms laser propagating in the THz QCL, and it is possible to convert the THz emission to near-infrared wavelengths.

Then, by comparing such a side mode with a coherent reference laser we can develop a phase lock circuit to stabilize the sideband mode.

FIG. 12(c) illustrates how phase locked lasers could be used to transmit digital data at high bit rates for example.

Graphene

Graphene is typically understood to be a monolayer of hexagonally packed carbon atoms. Nevertheless in the present invention, the graphene film (or graphene layer) need not be a monolayer. For example, the present invention is operable if the graphene film located in the at least one grating elements is up to 10 monolayers thick, up to 9 monolayers thick, up to 8 monolayers thick, up to 7 monolayers thick, up to 6 monolayers thick, up to 5 monolayers thick, up to 4 monolayers thick, up to 3 monolayers thick or up to 2 monolayers thick. Although a graphene monolayer is preferred.

Graphene is an atomically thick, two dimensional sheet composed of sp2 carbons in a honeycomb structure. It can be viewed as the building block for all the other graphitic carbon allotropes. Graphite (3-D) is made by stacking several layers on top of each other, with an interlayer spacing of ˜3.4 Å and carbon nanotubes (1-D) are a graphene tube. Graphane is hydrogenated graphene, the carbons of the C-H groups being sp3 carbons.

Single-layer graphene is one of the strongest materials ever measured, with a tensile strength of ˜130 GPa and possesses a modulus of ˜1 TPa. Graphene's theoretical surface area is ˜2630 m2/g and the layers are gas impermeable. It has very high thermal (5000+W/mK) and electrical conductivities (up to 6000 S/cm).

Graphene was first reported in 2004, following its isolation by Professor Geim's group.

Graphene research since then has increased rapidly. Much of the “graphene” literature is not on true monolayer graphene but rather two closely related structures:
(i) “few layer graphene”, which is typically 2 to 10 graphene layers thick. The unique properties of graphene are lost as more layers are added to the monolayer and at 10 layers the material becomes effectively bulk graphite; and
(ii) Graphene oxide (GO), which is a graphene layer which has been heavily oxidised in the exfoliation process used to make it and has typically 30 at % oxygen content. This material has inferior mechanical properties, poor electrical conductivity and is hydrophilic (hence a poor water barrier).

There are a variety of methods to produce graphene [Nature Nanotechnology, 2009, DOI: 10.1038/nnano.2009.58]. Novoselov et al. produced their first flakes by the mechanical exfoliation of graphite by using an adhesive tape to isolate individual layers [Science, 2004, 5296, pp 666-669]. It has been shown subsequently that graphite can also be exfoliated by using ultrasonic energy to separate the layers when in an appropriate solvent, such as NMP (N-methyl pyrrolidone) [Nat. Nanotechnol., 2008, 3, 563; J. Am. Chem. Soc., 2009, 131, 3611].

Graphite is an allotrope of carbon, the structure of which consists of graphene layers stacked along the c-axis in a staggered array usually denoted as ABAB. The layers are held together by weak van der Weals forces so that the separation between layers is 0.335 nm. Graphite is a cheap and abundant natural material, which makes it an excellent raw material for inexpensive production of graphene.

As noted above, graphite has been used to make graphene via exfoliation, wherein the stacked layers of graphite are separated to produce graphene. This has been achieved by using ultrasound (ultrasonic exfoliation, USE) and also by intercalating compounds into the graphite interlayer structure so as to weaken the interlayer bonding and promote layer separation.

There are two routes that have been reported to intercalate compounds into graphite structure: chemical and electrochemical. The chemical method is based on the direct reaction of solid graphite materials with the intercalation species (usually in liquid or vapour phase). This process is kinetically slow and usually assisted by sonication or heating. The second route, the electrochemical approach, involves generating the intercalated species through an electrochemical reaction on a graphite cathode or on a graphite anode.

The most famous example of the electrochemical approach is based on the lithium ion battery. For decades, graphite was used as negative electrode in lithium ion battery due to its high electrical conductivity and its ability to host lithium between the graphene layers. The lithium-graphite intercalation compounds decompose readily in water giving rise to lithium hydroxide and free standing graphene sheets. Loh et al. mimicked the lithium ion battery principle to intercalate Li into graphite and then applied a sonication step to exfoliate graphite [US 2013/0102084 A1, and WO 2011/162727]. This work is also discussed in a related paper [JACS, 2011, 133, 8888-8891]. However, due to the slow kinetic nature of the intercalation process, the lithium was limited to the areas close to the edges. Upon exfoliation in water, graphite with expanded edges was produced and further intercalation, water decomposition and sonication steeps were needed to achieve exfoliation.

Liu et al. [Adv. Funct. Mater. 2008, 18, pp. 1518-1525] reported the exfoliation of graphite using an ionic liquid-water mixture electrolyte to form “kind of IL-functionalized” graphene nanosheets. Scheme 1 in this paper suggests that the material was produced by the exfoliation of the anode but in their discussion the authors mention the role of the cation. Lu subsequently studied the route in more detail and discussed the possible mechanism involved in the production process [ACS Nano, 2009, 3(8) pp. 2367-2375]. In their paper, they stated “according to the proposed mechanism by Liu, the positively charged imidazolium ion is reduced at the cathode to form the imidazolium free radical which can insert into the bonds of the graphene plane. At the fundamental level, there are several questionable aspects about the radical-insertion mechanism proposed by Liu, especially when the ILs are mixed with water at 1:1 ratio and where an operational voltage as high as 15 V is applied”. Lu et al. showed that the graphene nanosheet production is exclusively at the anode and is due to an interaction of decomposed water species and the anions from the ionic liquid, such as BF₄_{^{−}}.

The following clauses describe aspects of the present invention:

A1. A tunable mixer comprising:
a solid state device formed of a (non-linear) material having a second or higher order electrical susceptibility, and configured to receive an input light signal having a principle modal frequency; and
a grating, provided as a series of a plurality of grating elements, arranged to provide distributed feedback within the device such that the mixer is electrically controllable:
   to add, relative to the principle modal frequency, a sideband mode to the input light signal at any selected one of at least two respective sideband modal frequencies; and
   to output the resulting light signal.

A2. A tunable mixer according to clause A1, wherein the mixer is electrically controllable to select the desired sideband mode frequency by adjustment of an electrical current input to the device.

A3. A tunable mixer according to clause A1 wherein the grating elements are arranged to provide scattering sites for radiation propagating in the device, and the tunable mixer further includes a graphene film provided for at least one of the grating elements, and arranged to alter the scattering effect of the at least one grating element.

A4. A tunable mixer according to clause A1 wherein the grating elements are arranged to provide scattering sites for radiation propagating within the device; and the mixer further includes
a first graphene film provided for each grating element of a first set of said grating elements, said first set of grating elements including at least one of the plurality of grating elements; and
a second graphene film provided for each grating element of a second set of said grating elements, said second set of grating elements including another at least one of the plurality of grating elements; wherein
the first graphene film is controllable, independently of the second graphene film, to alter the scattering effect of the first set of grating elements on the radiation propagating in the device thereby to permit selection of the frequency of the sideband mode.

A5. A tunable mixer according to clause A4 wherein the first and second graphene films are independently controllable respective portions of the same graphene film.

A6. A tunable mixer according to clause A1 wherein the device includes a waveguide for guiding the input light signal through the device.

A7. A tunable mixer according to clause A1 wherein the grating elements are arranged as an aperiodic series arranged to provide distributed feedback within the device such that the mixer is electrically controllable:
to add, relative to the principle modal frequency, a sideband mode to the input light signal at any selected one of at least three respective sideband modal frequencies; and
to output the resulting signal

A8. A tunable mixer according to clause A9 wherein the device is optically coupled to an optical input element to receive the input light signal therefrom, and optically coupled to an optical output element arranged to receive the signal output by the device including the principal mode and sideband mode.

A11. A tunable mixer according to clause A10 wherein the optical input element and/or the optical output element includes an optical fiber.

A12. A tunable mixer according to any one of the preceding clauses wherein the device is at least a portion of a solid state laser device.

A15. A tunable mixer according to clause A1 wherein the principle mode of the input light signal is in the near-infra red portion of the electromagnetic spectrum.

A16. A tunable mixer according to clause A15 wherein the sideband mode frequency differs from the principle mode by less than 50 THz.

A17. A tunable mixer according to clause A15 wherein the sideband mode frequencies differ from the principle mode by less than 10 THz.

A18. A phase locked terahertz mixing circuit comprising:
a terahertz mixer including
   a solid state device formed of a (non-linear) material having a second or higher order electrical susceptibility configured to receive an input light signal having a principle modal frequency, wherein the solid state device is electrically controllable to add, relative to the principle modal frequency, a sideband mode at a sideband modal frequency and to output the resulting signal;
a control sub-circuit including
   a comparison portion arranged to compare the instantaneous phase-angle of the sideband mode included in the signal output by the terahertz mixer with that of a reference signal at a reference frequency, and
   a control portion arranged to control the instantaneous phase angle of the sideband mode signal in the signal output by the terahertz mixer on the basis of the comparison.

A19. An phase locked terahertz mixing circuit according to clause A18, wherein
the comparison portion is arranged to make the comparison by determining a difference between the instantaneous phase-angle of the sideband mode in the resulting signal output by the terahertz mixer and the reference signal; and
the control portion is arranged to control the instantaneous phase angle of the sideband mode in the signal output by the terahertz mixer on the basis of the determined difference.

A20. A phase locked terahertz mixing circuit according to clause A19 whereby the comparison portion is adapted to use a square law detector to measure the difference.

A21. A phase locked terahertz mixing circuit according to clause A19, wherein the control portion is arranged to control the instantaneous phase angle of the sideband mode in the signal output by the terahertz mixer to control the determined difference between the output sideband modal frequency and the reference frequency.

A22. A phase locked terahertz mixing circuit according to clause A21 wherein the difference is compared using a phase frequency detector to produce a control signal.

A23. A phase locked terahertz mixing circuit according to clause A22wherein the control portion is arranged to control the sideband mode instantaneous phase-angle through electrical control the terahertz mixer

A24. A phase locked terahertz mixing circuit according to clause A18 wherein the terahertz mixer further includes a grating, provided as a series of a plurality of grating elements, arranged to provide distributed feedback within the device such that the mixer is electrically controllable to add, relative to the principle modal frequency, a sideband mode to the input light signal at any selected one of at least two respective sideband modal frequencies.

A25. A phase locked terahertz mixing circuit according to clause A18, further including an optical fiber arranged to receive the signal output by the terahertz mixer and convey the signal along at least a portion of its length.

A26. A phase locked terahertz mixing circuit according to clause A25, wherein the optical fiber is coupled to the terahertz mixer to receive the signal output thereby.

A27. A phase locked terahertz mixing circuit according to clause A25, wherein the comparison portion is arranged to make the comparison on the basis of the signal conveyed by the optical fiber.

A28. A phase locked terahertz mixing circuit according to clause A18, further including an input optical fiber arranged to couple the input signal into the terahertz mixer.

A29. A phase locked terahertz mixing circuit according to clause A18, wherein the instantaneous phase angle indicates both frequency and phase.

A30. A method of controlling a phase locked terahertz mixing circuit according to any one of clause A18 comprising the steps of:
acquiring an output signal of the terahertz mixer having a principal mode at a principal modal frequency and a sideband mode at a sideband modal frequency;
comparing the instantaneous phase-angle of the sideband mode signal with that of the reference signal;
controlling the value of the sideband modal frequency and phase output by the terahertz mixer on the basis of the comparison.

A31. A method according to clause A30 wherein the step of comparing includes a step of determining an instantaneous phase-angle difference between the sideband mode signal and the reference signal; and the step of controlling includes the step of controlling the value of the instantaneous phase-angle sideband mode output by the terahertz mixer on the basis of the determined difference.

A32. A method according to clause A31, including the step of controlling the terahertz mixer to control (or minimize) the determined instantaneous phase-angle difference between the output sideband mode signal and the reference signal.

A33. A method of according to clause A30, wherein the mixer includes a solid state device formed of a (non-linear) material having a second or higher order electrical susceptibility configured to receive an input light signal at the principle modal frequency; wherein the method includes:
electrically controlling the solid state device to add, relative to the principle modal frequency, the sideband mode at the sideband modal frequency.

A34. A method according to clause A30, wherein the mixer further includes a grating arranged to provide distributed feedback within the device; wherein the grating is provided as a series of a plurality of grating elements; and
wherein the method includes electrically controlling the mixer to add, relative to the principle modal frequency, the sideband mode to the input light signal at any selected one of at least two respective sideband modal frequencies.

### LIST OF CITATIONS FOR THE FIRST EXAMPLE

[1] S. S. Dhillon, C. Sirtori, J. Alton, S. Barbieri, A. de Rossi, H. E. Beere, and D. A. Ritchie, “Terahertz transfer onto a telecom optical carrier,” Nat. Photonics, vol. 1, no. 7, pp. 411-415, July 2007.
[2] L. N. Langley, M. D. Elkin, C. Edge, M. J. Wale, U. Gliese, X. Huang, and A. J. Seeds, “Packaged semiconductor laser optical phase-locked loop (OPLL) for photonic generation, processing and transmission of microwave signals,” IEEE Trans. Microw. Theory Tech., vol. 47, no. 7, pp. 1257-1264, July 1999.
[3] J. M. Hensley, J. Montoya, M. G. Allen, J. Xu, L. Mahler, A. Tredicucci, H. E. Beere, and D. A. Ritchie, “Spectral behavior of a terahertz quantum-cascade laser.,” Opt. Express, vol. 17, no. 22, pp. 20476-83, October 2009.
[4] O. P. Marshall, M. Khairuzzaman, H. E. Beere, D. A. Ritchie, and S. Chakraborty, “Broadband photonic control for dual-mode terahertz laser emission,” Appl. Phys. Lett., vol. 102, no. 18, p. 181106, 2013.

### LIST OF CITATIONS FOR THE SECOND EXAMPLE

[1] J. M. Hensley, J. Montoya, M. G. Allen, J. Xu, L. Mahler, A. Tredicucci, H. E. Beere, and D. A. Ritchie, “Spectral behavior of a terahertz quantum-cascade laser.,” Opt. Express, vol. 17, no. 22, pp. 20476-83, October 2009.
[2] S. S. Dhillon, C. Sirtori, J. Alton, S. Barbieri, A. de Rossi, H. E. Beere, and D. A. Ritchie, “Terahertz transfer onto a telecom optical carrier,” Nat. Photonics, vol. 1, no. 7, pp. 411-415, July 2007.
[3] O. P. Marshall, M. Khairuzzaman, H. E. Beere, D. A. Ritchie, and S. Chakraborty, “Broadband photonic control for dual-mode terahertz laser emission,” Appl. Phys. Lett., vol. 102, no. 18, p. 181106, 2013.
[4] M. S. Vitiello, G. Scamarcio, and V. Spagnolo, “Time-resolved measurement of the local lattice temperature in terahertz quantum cascade lasers,” Appl. Phys. Lett., vol. 92, no. 10, p. 101116, March 2008.

### LIST OF CITATIONS FOR THE THIRD EXAMPLE

1. Dhillon, S. S. et al. Terahertz transfer onto a telecom optical carrier. Nat. Photonics 1, 411-415 (2007).
2. Maineult, W. et al. Microwave modulation of terahertz quantum cascade lasers: a transmission-line approach. Appl. Phys. Lett. 96, 021108 (2010).
3. Madén, J. et al. All-optical wavelength shifting in a semiconductor laser using resonant nonlinearities. Nat. Photonics 6, 519-524 (2012).
4. Mahler, L. et al. Single-mode operation of terahertz quantum cascade lasers with distributed feedback resonators. Appl. Phys. Lett. 84, 5446 (2004).
5. Docter, B. et al. Discretely Tunable Laser Based on Filtered Feedback for Telecommunication Applications. IEEE J. Sel. Top. Quantum Electron. 16, 1405-1412 (2010).
6. Jung, S. et al. Broadly tunable monolithic room-temperature terahertz quantum cascade laser sources. Nat. Commun. 5, 4267 (2014).
7. Belkin, M. A. et al. Terahertz quantum-cascade-laser source based on intracavity difference-frequency generation. Nat. Photonics 1, 288-292 (2007).
8. Mahler, L. et al. Quasi-periodic distributed feedback laser. Nat. Photonics 4, 165-169 (2010).
9. Martins, E. R. et al. Deterministic quasi-random nanostructures for photon control. Nat. Commun. 4, 2665 (2013).
10. Chakraborty, S., Parker, M. C. & Mears, R. J. A Fourier (k-) space design approach for controllable photonic band and localization states in aperiodic lattices. in PECS-VI 25 (2005). at <http://arxiv.org/abs/physics/0509227>
11. Chakraborty, S. et al. Longitudinal computer-generated holograms for digital frequency control in electronically tunable terahertz lasers. Appl. Phys. Lett. 101, 121103 (2012).
12. Centini, M. et al. Dispersive properties of finite, one-dimensional photonic band gap structures: Applications to nonlinear quadratic interactions. Phys. Rev. E 60, 4891-4898 (1999).
13. Sibilia, C., Nefedov, I. S., Scalora, M. & Bertolotti, M. Electromagnetic mode density for finite quasi-periodic structures. J. Opt. Soc. Am. B 15, 1947 (1998).
14. Toll, J. Causality and the Dispersion Relation: Logical Foundations. Phys. Rev. 104, 1760-1770 (1956).
15. Papoulis, A. The Fourier Integral and its Applications. 193-217 (Mc Graw-Hill, 1962).
16. Dowling, J. P., Scalora, M., Bloemer, M. J. & Bowden, C. M. The photonic band edge laser: A new approach to gain enhancement. J. Appl. Phys. 75, 1896 (1994).
17. Berger, V. & Sirtori, C. Nonlinear phase matching in THz semiconductor waveguides. Semicond. Sci. Technol. 19, 964-970 (2004).
18. Dumeige, Y. et al. Enhancement of second-harmonic generation in a one-dimensional semiconductor photonic band gap. Appl. Phys. Lett. 78, 3021 (2001).
19. Bloembergen, N. NONLINEAR OPTICAL PROPERTIES OF PERIODIC LAMINAR STRUCTURES. Appl. Phys. Lett. 17, 483 (1970).
20. Fejer, M. M., Magel, G. A., Jundt, D. H. & Byer, R. L. Quasi-phase-matched second harmonic generation: tuning and tolerances. IEEE J. Quantum Electron. 28, 2631-2654 (1992).
21. Gu, B.-Y., Dong, B.-Z., Zhang, Y. & Yang, G.-Z. Enhanced harmonic generation in aperiodic optical superlattices. Appl. Phys. Lett. 75, 2175 (1999).
22. Chakraborty, S. et al. Discrete mode tuning in terahertz quantum cascade lasers. Opt. Express 20, B306-14 (2012).
23. Dhillon, S. S. et al. THz sideband generation at telecom wavelengths in a GaAs-based quantum cascade laser. Appl. Phys. Lett. 87, 071101 (2005).
24. Marshall, 0. P. et al. Electronically tunable aperiodic distributed feedback terahertz lasers. J. Appl. Phys. 113, 203103 (2013).
25. Khairuzzaman, M., Marshall, 0. P., Beere, H., Ritchie, D. & Chakraborty, S. Aperiodic Lattice-Modified Mode Pulling in THz Lasers. in CLEO 2013 JTu1J.6 (OSA, 2013). doi: 10.1364/CLEO_SI.2013.JTu1J.6

1. A tunable mixer comprising:
a solid state device formed of a (non-linear) material having a second or higher order electrical susceptibility, and configured to receive an input light signal having a principle modal frequency; and
a grating, provided as a series of a plurality of grating elements, arranged to provide distributed feedback within the device such that the mixer is electrically controllable:
to add, relative to the principle modal frequency, a sideband mode to the input light signal at any selected one of at least two respective sideband modal frequencies; and
to output the resulting light signal.

2. A tunable mixer according to claim 1, wherein the mixer is electrically controllable to select the desired sideband mode frequency by adjustment of an electrical current input to the device.

3. A tunable mixer according to claim 1 wherein the grating elements are arranged to provide scattering sites for radiation propagating in the device, and the tunable mixer further includes a graphene film provided for at least one of the grating elements, and arranged to alter the scattering effect of the at least one grating element.

4. A tunable mixer according to claim 1 wherein the grating elements are arranged to provide scattering sites for radiation propagating within the device; and the mixer further includes
a first graphene film provided for each grating element of a first set of said grating elements, said first set of grating elements including at least one of the plurality of grating elements; and
a second graphene film provided for each grating element of a second set of said grating elements, said second set of grating elements including another at least one of the plurality of grating elements; wherein
the first graphene film is controllable, independently of the second graphene film, to alter the scattering effect of the first set of grating elements on the radiation propagating in the device thereby to permit selection of the frequency of the sideband mode.

5. A tunable mixer according to claim 4 wherein the first and second graphene films are independently controllable respective portions of the same graphene film.

6. A tunable mixer according to claim 1 wherein the device includes a waveguide for guiding the input light signal through the device.

7. A tunable mixer according to claim 1 wherein the grating elements are arranged as an aperiodic series arranged to provide distributed feedback within the device such that the mixer is electrically controllable:
to add, relative to the principle modal frequency, a sideband mode to the input light signal at any selected one of at least three respective sideband modal frequencies; and
to output the resulting signal

8. A tunable mixer according to claim 9 wherein the device is optically coupled to an optical input element to receive the input light signal therefrom, and optically coupled to an optical output element arranged to receive the signal output by the device including the principal mode and sideband mode.

9. A tunable mixer according to claim 8 wherein the optical input element and/or the optical output element includes an optical fiber.

10. A tunable mixer according to claim 1 wherein the device is at least a portion of a solid state laser device.

11. A tunable mixer according to claim 1 wherein the principle mode of the input light signal is in the near-infra red portion of the electromagnetic spectrum.

12. A tunable mixer according to claim 11 wherein the sideband mode frequency differs from the principle mode by less than 50 THz.

13. A tunable mixer according to claim 11 wherein the sideband mode frequencies differ from the principle mode by less than 10 THz.

14. A phase locked terahertz mixing circuit comprising:
a terahertz mixer including
a solid state device formed of a (non-linear) material having a second or higher order electrical susceptibility configured to receive an input light signal having a principle modal frequency, wherein the solid state device is electrically controllable to add, relative to the principle modal frequency, a sideband mode at a sideband modal frequency and to output the resulting signal;
a control sub-circuit including
a comparison portion arranged to compare the instantaneous phase-angle of the sideband mode included in the signal output by the terahertz mixer with that of a reference signal at a reference frequency, and
a control portion arranged to control the instantaneous phase angle of the sideband mode signal in the signal output by the terahertz mixer on the basis of the comparison.

15. An phase locked terahertz mixing circuit according to claim 14, wherein
the comparison portion is arranged to make the comparison by determining a difference between the instantaneous phase-angle of the sideband mode in the resulting signal output by the terahertz mixer and the reference signal; and
the control portion is arranged to control the instantaneous phase angle of the sideband mode in the signal output by the terahertz mixer on the basis of the determined difference.

16. A phase locked terahertz mixing circuit according to claim 15 whereby the comparison portion is adapted to use a square law detector to measure the difference.

17. A phase locked terahertz mixing circuit according to claim 15, wherein
the control portion is arranged to control the instantaneous phase angle of the sideband mode in the signal output by the terahertz mixer to control the determined difference between the output sideband modal frequency and the reference frequency.

18. A phase locked terahertz mixing circuit according to claim 17 wherein the difference is compared using a phase frequency detector to produce a control signal.

19. A phase locked terahertz mixing circuit according to claim 17 wherein the control portion is arranged to control the sideband mode instantaneous phase-angle through electrical control the terahertz mixer

20. A phase locked terahertz mixing circuit according to claim 18 wherein
the terahertz mixer further includes a grating, provided as a series of a plurality of grating elements, arranged to provide distributed feedback within the device such that the mixer is electrically controllable to add, relative to the principle modal frequency, a sideband mode to the input light signal at any selected one of at least two respective sideband modal frequencies.

21. A phase locked terahertz mixing circuit according to claim 14, further including an optical fiber arranged to receive the signal output by the terahertz mixer and convey the signal along at least a portion of its length.

22. A phase locked terahertz mixing circuit according to claim 21, wherein the optical fiber is coupled to the terahertz mixer to receive the signal output thereby.

23. A phase locked terahertz mixing circuit according to claim 21, wherein the comparison portion is arranged to make the comparison on the basis of the signal conveyed by the optical fiber.

24. A phase locked terahertz mixing circuit according to claim 14, further including an input optical fiber arranged to couple the input signal into the terahertz mixer.

25. A phase locked terahertz mixing circuit according to claim 14, wherein the instantaneous phase angle indicates both frequency and phase.

26. A method of controlling a phase locked terahertz mixing circuit according to any one of claim 14 comprising the steps of:
acquiring an output signal of the terahertz mixer having a principal mode at a principal modal frequency and a sideband mode at a sideband modal frequency;
comparing the instantaneous phase-angle of the sideband mode signal with that of the reference signal;
controlling the value of the sideband modal frequency and phase output by the terahertz mixer on the basis of the comparison.

27. A method according to claim 26 wherein the step of comparing includes a step of determining an instantaneous phase-angle difference between the sideband mode signal and the reference signal; and the step of controlling includes the step of controlling the value of the instantaneous phase-angle sideband mode output by the terahertz mixer on the basis of the determined difference.

28. A method according to claim 26, including the step of controlling the terahertz mixer to control (or minimize) the determined instantaneous phase-angle difference between the output sideband mode signal and the reference signal.

29. A method of according to claim 26, wherein the mixer includes a solid state device formed of a (non-linear) material having a second or higher order electrical susceptibility configured to receive an input light signal at the principle modal frequency; wherein the method includes:
electrically controlling the solid state device to add, relative to the principle modal frequency, the sideband mode at the sideband modal frequency.

30. A method according to claim 26, wherein the mixer further includes a grating arranged to provide distributed feedback within the device; wherein the grating is provided as a series of a plurality of grating elements; and
wherein the method includes electrically controlling the mixer to add, relative to the principle modal frequency, the sideband mode to the input light signal at any selected one of at least two respective sideband modal frequencies.
